(19) United States
(12) Patent Application Publication
(10) Pub. No.: US 2025/0024492 A1
(43) Pub. Date: Jan. 16, 2025

(54) COMMUNICATION ON UNLICENSED FREQUENCY BANDS

(71) Applicant: Telefonaktiebolaget LM Ericsson (publ), Stockholm (SE)

(72) Inventors: Muhammad Ali KAZMI, Sundbyberg (SE); Chunhui ZHANG, Stockholm (SE); Santhan THANGARASA, Vällingby (SE); Zhixun TANG, Beijing (CN)

(21) Appl. No.: 18/714,321

(22) PCT Filed: Dec. 27, 2021
(86) PCT No.: PCT/SE2021/051314

§ 371 Date: May 29, 2024

(30) Foreign Application Priority Data
Nov. 29, 2021 (WO) PCT/CN2021/133921

(51) Int. Cl. H04W 74/0808; H04W 16/14; H04W 68/00

(52) U.S. Cl. CPC H04W 74/0808; H04W 68/005; H04W 16/14

(57) ABSTRACT

There is disclosed a method of operating a wireless device in a wireless communication network, the wireless device being adapted for operating based on a clear channel assessment, CCA, on at least one carrier and/or cell for which an eDRX cycle is configured. The method includes performing one or more radio procedures based on one or more CCA parameters. The disclosure also pertains to related devices and methods.

### TECHNICAL FIELD

This disclosure pertains to wireless communication technology, in particular for high frequencies.

### BACKGROUND

Wireless devices with a wide range of different capabilities are being introduced, which can lead to complicated and unpredictable interactions in different scenarios. In particular, operation on unlicensed carrier or bands may introduce challenges for communication also utilising power saving techniques like eDRX.

### SUMMARY

It is an object of this disclosure to provide approaches improved operation in wireless communication involving unlicensed carriers and eDRX.

There is disclosed a method of operating a wireless device in a wireless communication network. The wireless device is adapted and/or configured for operating based on a clear channel assessment, CCA, on at least one carrier and/or cell for which eDRX and/or an eDRX cycle is configured. The method comprises performing one or more radio procedures based on one or more CCA parameters.

A wireless device for a wireless communication network is proposed. The wireless device is adapted and/or configured for operating based on a clear channel assessment, CCA, on at least one carrier and/or cell for which eDRX and/or an eDRX cycle is configured. The wireless device further is adapted and/or configured for performing one or more radio procedures based on one or more CCA parameters.

A method of operating a network node in a wireless communication network is described. The network node is adapted and/or configured for operating based on a clear channel assessment, CCA, on at least one carrier and/or cell for which eDRX and/or an eDRX cycle is configured. The method comprises performing one or more radio procedures based on one or more CCA parameters.

Furthermore, a network node for a wireless communication network is considered. The network node is adapted and/or configured for operating based on a clear channel assessment, CCA, on at least one carrier and/or cell for which eDRX and/or an eDRX cycle is configured. The network node is configured and/or adapted for performing one or more radio procedures based on one or more CCA parameters.

Alternatively, or additionally, any method of operating a wireless device or UE, and/or any wireless device or UE, and/or any method of operating a network node, and/or any network node, as described in this disclosure may be considered. A method of operating a node may be considered a method in the node, and/or performed by the node.

Being adapted or configured for operating based on a CCA on at least one carrier or cell may comprise and/or refer to being set up to access the cell and/or carrier for transmission based on CCA, and/or being set up for receiving based on possible transmission being dropped based on failed CCAs. Performing one or more radio procedures may comprise and/or represent and/or be based on communicating and/or transmitting a signal and/or signalling, and/or receiving a signal and/or signalling, and/or performing measurement/s and/or monitoring for a paging (e.g., a paging message and/or paging signalling). Communicating may comprise and/or represents transmitting and/or receiving and/or performing measurement/s and/or measurement reporting. A cell and/or carrier for which a eDRX cycle is configured may refer to at least one radio node operating on the cell or carrier being operating, and/or being configured and/or adapted for operating, using eDRX, e.g., according to the eDRX cycle. In particular, a wireless device may be configured for eDRX on a cell or carrier, e.g. based on a configuration provided by a network node, e.g. with higher layer signalling.

It may be considered that the one or more radio procedures comprise performing measurement and/or measurement reporting. Accordingly, influences of CCA on measurements during eDRX (which may lead to only few measurement opportunities in a time interval) may be accommodated for.

In general, performing the one or more radio procedures may be based on a Paging Time Window, PTW, and/or a PTW (e.g., duration, or occasion and/or location in time and/or periodicity) being based on one or more CCA parameters. Thus, the PTW may be adapted to accommodate possible issues with failed CCA, for example. In general, performing one or more radio procedures based on one or more CCA parameters may comprise and/or be based on, and/or may comprise adapting, one or more eDRX parameters, and/or one or more DRX parameters, based on the one or more CCA parameters. In general, being configured for eDRX may comprise and/or be based on being configured for DRX. Being configured for DRX may be analogous to being configured for eDRX, e.g., for the base DRX functionality.

In some variants, the one or more CCA parameters may comprise (e.g., one or more of) determining success or failure of a CCA procedure, and/or number of CCA procedures, and/or number of successful or failed CCA procedures, and/or one or more time intervals, e.g., for determining a number of CCA procedures and/or successful and/or failed CCA procedures, and/or one or more occasions, e.g., for paging and/or transmission and/or reception.

The approaches are particularly advantageously implemented in a future 5G or 6^{th} Generation (6G) telecommunication network or 6G radio access technology or network (RAT/RAN), in particular according to 3GPP (3^{rd} Generation Partnership Project, a standardisation organization). A suitable RAN may in particular be a RAN according to NR, for example release 17 or later, or LTE Evolution. However, the approaches may also be used with other RAT, for example future 5.5G systems or IEEE based systems.

It may be considered that the RAN and/or a radio node is operating in an unlicensed frequency band (or carrier or part thereof, also referred to as license-exempt) and/or based on a LBT or channel assessment procedure to access (for transmission) the frequency band (or carrier or part thereof), for example in a License Assisted Access (LAA) operation mode and/or in the context of NR-U (NR unlicensed).

In some cases, the wireless device and/or network node may be adapted to operate on one or more licensed carriers and/or cells, and/or on one or more carriers not configured for CCA, e.g., on a different frequency spectrum than the carrier/s and/or cell/s configured for CCA. The cells and/or carriers a node operates on and/or is adapted or configured to operate on may be part of the same carrier aggregation. For example, a cell or carrier without CCA may be configured as primary component carrier or cell, a cell or carrier with CCA may be configured a secondary component carrier or cell.

There is also described a program product comprising instructions causing processing circuitry to control and/or perform a method as described herein.

Moreover, a carrier medium arrangement carrying and/or storing a program product as described herein is considered. An information system comprising, and/or connected or connectable, to a radio node is also disclosed.

### BRIEF DESCRIPTION OF THE DRAWINGS

The drawings are provided to illustrate concepts and approaches described herein, and are not intended to limit their scope. The drawings comprise:

FIG. 1, showing an exemplary DRX cycle illustrating on and off durations;

FIG. 2, showing an exemplary DRX cycle operation illustrating different DRX related parameters;

FIG. 3, showing an exemplary DRX cycle shows variation in on and off durations due to UE receiver activity;

FIG. 4, showing exemplary data transmission scenarios;

FIG. 5, showing an exemplary H-SFN cycle;

FIG. 6, showing an exemplary CCA procedure and COT;

FIG. 7, showing an exemplary Np number of DRX cycles within PTW of the configured eDRX cycle;

FIG. 8, showing an exemplary radio node like a wireless device; and

FIG. 9, showing another exemplary radio node like a network node.

### DETAILED DESCRIPTION

In the following, approaches are described with reference to NR/REDCAP. However, they may be applicable broadly to other systems/RATs.

Procedures and requirements to support reduced capability (Redcap) UE, which entails characteristics like low complexity or low power consumption are being specified in Rel-17. A RedCap UE as an example of a wireless device will support the following UE complexity reduction features:
Reduced maximum UE bandwidth e.g. 20 MHz for FR1 (Frequency Range 1 as defined by NR) and 100 MHz for FR2 (Frequency Range 2 as defined by NR); Reduced minimum number of receiver (Rx) branches e.g. 1 or 2 Rx branches depending on redcap UE capability;
Maximum number of DL MIMO layers e.g. 1 or 2 layers depending on redcap UE capability;
Relaxed maximum modulation order e.g. 256 QAM in DL for Redcap UE in FR1 is optional;
Duplex operation: FDD, HD-FDD and TDD

### DRX Cycle Operation

The UE can be configured with a DRX cycle to use in all RRC states (e.g. RRC idle state, RRC inactive state and RRC connected state) to save UE battery power. Examples of lengths of DRX cycles currently used in RRC idle/inactive state are 320 ms, 640 ms, 1.28 s, 2.56 s etc. Examples of lengths of DRX cycles currently used in RRC connected state may range from 2 ms to 10.24 s. The DRX cycle is configured by the network node and/r being configured with DRX or a DRX cycle may be characterized by one or more of the following parameters (which may be considered DRX parameters):

On duration: During the on duration of the DRX cycle, a timer called ‘onDurationTimer’, which is configured by the network node, is running. This timer specifies the number of consecutive control channel subframes (e.g. NPDCCH slots) at the beginning of a DRX Cycle. It is also interchangeably called as DRX ON period. It is the duration (e.g. in number of downlink subframes) during which the UE after waking up from DRX may receive control channel (e.g. NPDCCH, wake up signal etc). If the UE successfully decodes the control channel (e.g. NPDCCH) during the on duration then the UE starts a drx-inactivity timer (see below) and stays awake until its expiry.

drx-inactivity timer: It specifies the number of consecutive control channel (e.g. NPDCCH,) subframe(s) after the subframe in which a control channel (e.g. NPDCCH) indicates an initial UL or DL user data transmission for this MAC entity. It is also configured by the network node.

DRX active time: This time is the duration during which the UE monitors the control channel (e.g. NPDCCH, wake up signals etc). In other words, this is the total duration during which the UE is awake. This includes the “on-duration” of the DRX cycle, the time during which the UE is performing continuous reception while the inactivity timer has not expired and the time the UE is performing continuous reception while waiting for a DL retransmission after one HARQ RTT. This means duration over which the drx-inactivity timer is running is called as DRX active time i.e. no DRX is used by the UE.

DRX inactive time: The time during the DRX cycle other than the active time is called as DRX inactive time i.e. DRX is used by the UE.

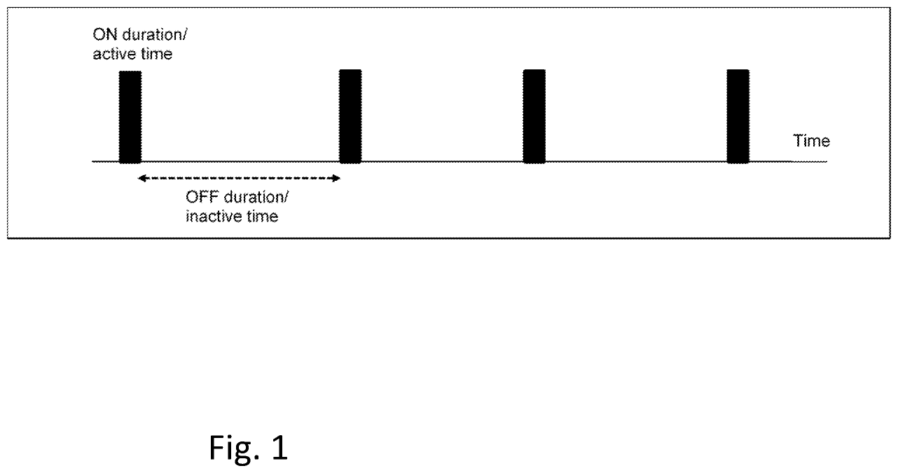

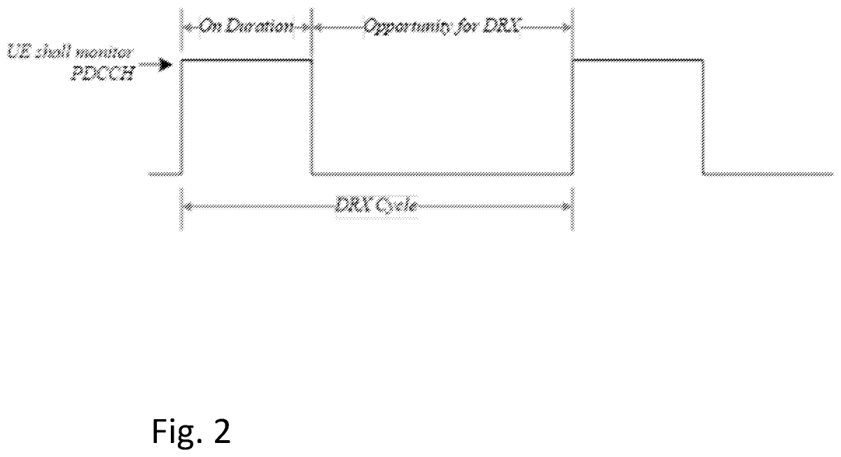

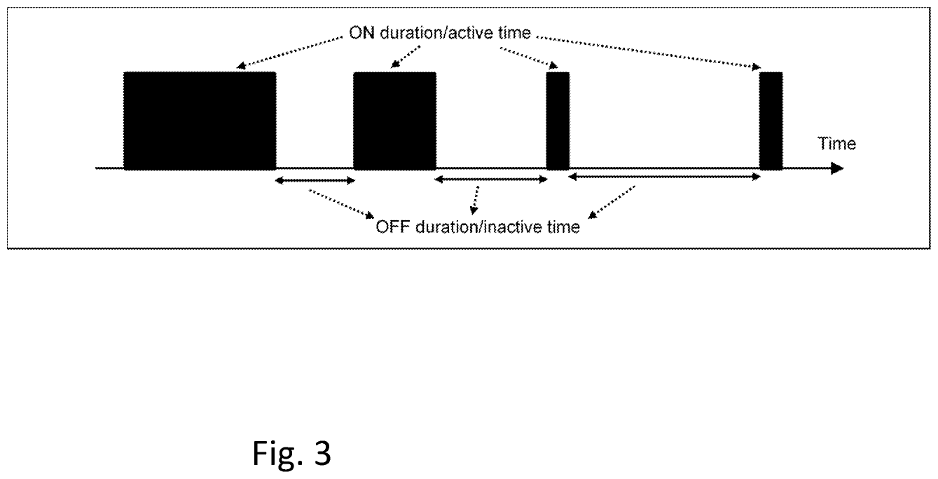

The DRX active time and DRX inactive time are also called as DRX ON and DRX OFF durations of the DRX cycle respectively are shown in FIG. 1. The DRX inactive time may also be called as non-DRX or non-DRX period. The DRX operation with more detailed parameters is illustrated in FIG. 2. FIG. 3 shows that the DRX active and inactive times may vary depending on UE receiver activity e.g. DRX inactivity timer is running upon UE being scheduled. This in turn increases DRX active time and proportionally shortened the DRX inactive time.

In NR, an enhanced DRX (eDRX) cycle is being specified for UE in RRC_IDLE and RRC_INACTIVE. The purpose of eDRX cycle is further enable UE power saving even more than achieved by the UE when configured only with DRX cycle. The eDRX ranges between few seconds to several minutes or even hours. In one example eDRX cycle may range from 5.12 seconds (shortest eDRX) up to 10485.76 s (largest eDRX). eDRX cycle may also be multiple of 1.28 second which is typical DRX cycle used in idle and inactive states.

eDRX configuration parameters (eDRX parameters) may be negotiated between UE and the network via higher layer signaling e.g. via non-access stratum (NAS) messages, and/or may be configured to the UE or wireless device by the network node, e.g. based on the negotiation. During the negotiation the network transmits eDRX parameters, which may comprise eDRX cycle length; paging time window (PTW), hyper system frame number (H-SFN), paging H-SFN (PH) etc.

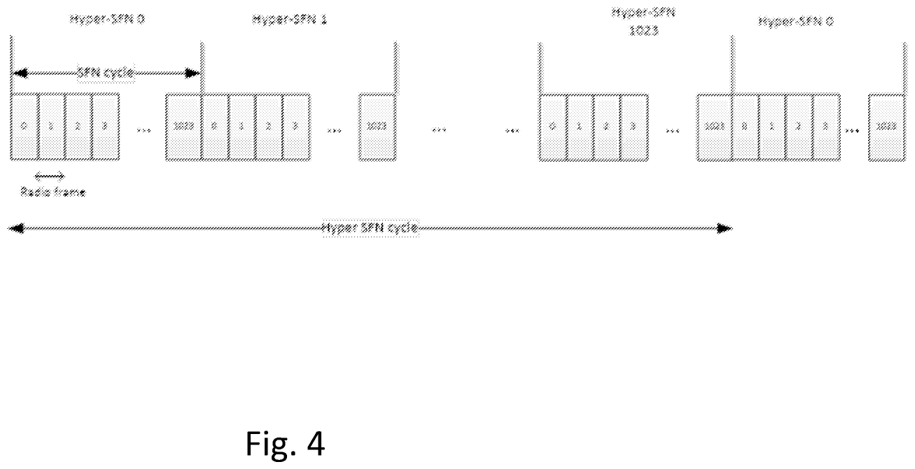

H-SFN comprise of multiple SFN cycles as shown in FIG. 4. A SFN cycle is a counter which initializes after certain number of frames. In one example SFN cycle comprising of 1024 frames i.e. varies from 0 to 1023. H-SFN is a frame structure on top of the legacy SFN structure, where each H-SFN value corresponds to a cycle of legacy frames (e.g. 1024 frames) and one H-SFN cycle contains X1 number of SFN cycles e.g. X1=1024. The network (e.g. core NW such as MMEs, BS, gNodeBs etc) have the same H-SFN, and cells broadcast their H-SFN via system information e.g. SIB. The boundaries of the eDRX acquisition period are determined by H-SFN values for which H-SFN mod X1=0 e.g. X1=256.

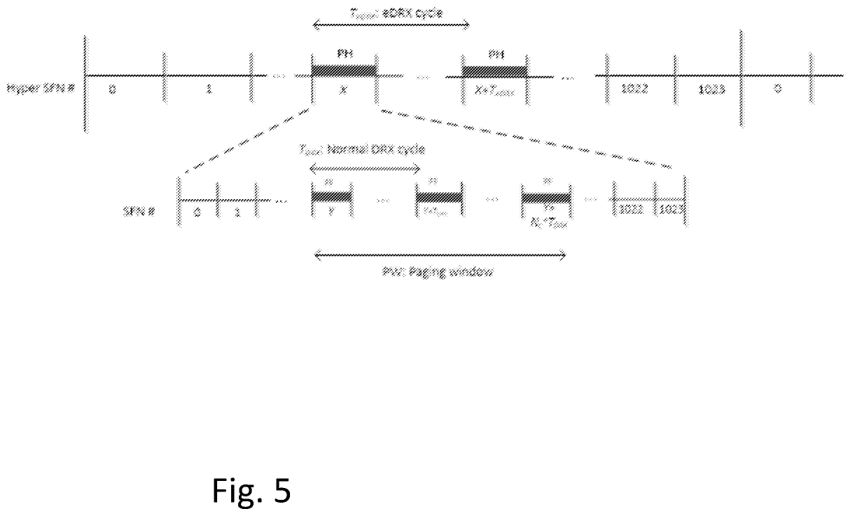

The UE is configured with PTW by the NW (e.g. by MME) via NAS during e.g. attach/tracking area update. The beginning of PTW may be calculated by a pre-defined formula (as described below). Within a PTW, the UE is further configured with one or more legacy DRX cycles as shown in FIG. 5. The PTW length may be expressed in terms of any one or more of: number of DRX cycles, multiples of certain time period (e.g. multiple of 1.28 second periods) or in absolute time (e.g. Y1 seconds) etc.

In one example PTW is characterized by or determined by the UE using the following mechanism:
Paging H-SFN (PH) (calculated by a formula):
   H-SFN mod TeDRX=(UE_ID mod TeDRX)
   UE_ID: IMSI mod X2 e.g. X2=1024
   TeDRX: eDRX cycle of the UE, (TeDRX=1, 2, . . . , X3 in hyper-frames) and configured by upper layers e.g. X3=256.
PTW start is calculated within PH as follows:
   The start of PTW is uniformly distributed across X4 (e.g. X4=4) paging starting points within the PH.
   PTW_start denotes the first radio frame of the PH that is part the paging window and has SFN satisfying the following equation:
   SFN=X3* ieDRX, where ieDRX=floor (UE_ID/TeDRX,H) mod X4
   PTW_end is the last radio frame of the PTW and has SFN satisfying the following equation:
   SFN=(PW_start+L*X5-X6) mod X2, e.g. X5=100, X6=1, where:
      L=Paging Window length (in seconds) configured by upper layers e.g. via RRC.
PTW length (configured by higher layers).

Unlicensed operation in NR is described. The unlicensed spectrum can be shared between multiple networks. In a variant, a device/node prior to transmission on a channel on an unlicensed spectrum may perform a Clear Channel Assessment (CCA) to assess or determine whether the channel is busy or not. The CCA procedure is also called as listen before talk (LBT). A CCA may comprise or consist of monitoring the channel for a certain specified time and measuring the received energy and/or in some technologies (e.g., Wi-Fi) checking for preamble transmission indicating the beginning of another device's transmission. The device is allowed to transmit signals on the channel provided that the channel is assessed (e.g., based on CCA) to be idle, which may also be called as clear channel, free channel, available channel, unused channel or channel not busy. The channel is assessed to be idle provided that the received energy or power during the sensing time duration is below a certain energy detection threshold; otherwise, the channel is considered to be busy. The example of energy detection level threshold is −72 dBm, which may further depend on the channel bandwidth e.g., −72 dBm and −75 dBm for 20 MHz and 10 MHz respectively. If the channel is assessed as “busy” then the device (UE or BS) is required to defer transmission.

After sensing the channel to be idle, the device/node is typically allowed to transmit for a certain amount of time, sometimes referred to as the Channel Occupancy Time (COT) or Maximum Channel Occupancy Time (MCOT). The maximum allowed length of the COT depends on regulation and type of CCA (e.g., for how long time the medium was sensed e.g., sensing duration) that has been performed—The COT typically ranges between 1 ms and 10 ms.

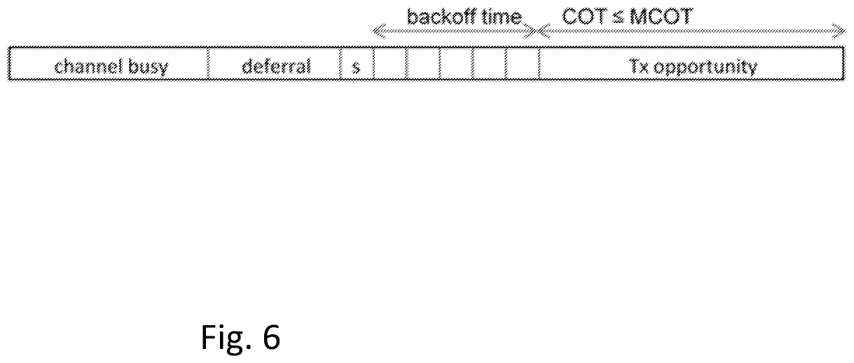

FIG. 6 shows LTE LBT and COT, where “s” is the sensing time period. In one example the sensing period can be 25 μs. In this figure, if the channel is determined to be busy, after some deferral time the device may try again to sense on the channel in order to determine whether the channel is available, and if so after some backoff time the device may start transmitting signal (during the device's channel occupancy time) but for no longer than the maximum channel occupancy time (MCOT) which can be e.g. up to 10 ms, depending on the region. The backoff time may be deterministic or statistical.

The eDRX related procedures and requirements are being specified for redcap UE in Rel-17. The redcap UE can support licensed bands as well as unlicensed bands (e.g. NR bands n46, n96, n100 etc). Measurement procedures for redcap UE used for licensed operation may be unsuitable for operating in unlicensed band. The operation on a carrier belonging to unlicensed band may be subject to CCA, e.g. CCA may be applied by the device (e.g. UE/BS) before transmission. The eDRX related measurement procedures for operation on a carrier subject to CCA can be very different compared to those on a carrier which is not subject to CCA (i.e. belonging to licensed band). Using eDRX procedures for licensed band for operation on unlicensed bands may lead to inappropriate operation on unlicensed band. When configured with eDRX operation, the UE operates signals during the PTW which occurs once every eDRX cycle. In particular, issues may arise during the PTW then firstly the mobility may fail and secondly the UE may miss the paging. Therefore, new procedure and requirements are needed for the UE when configured with carrier subject to CCA and with eDRX cycle.

This disclosure describes a scenario in which the UE is configured with at least a first cell (cell1) on a carrier frequency subject to CCA and with an extended DRX cycle (eDRX) and a DRX cycle, e.g., via higher layer signaling. The DRX cycle≤eDRX cycle (e.g., DRX=1.28 s and eDRX=10.24, or similar).

Approaches both for the UE and the network node (e.g., BS, core NW node etc) are described.

A first variant may pertain to method in a UE of adapting one or more procedures associated with eDRX cycle and applying the one or more adapted procedures for performing one or more radio operations (e.g., performing measurements, receiving paging etc). Examples of the adapted procedures are:

In one example, the UE adapts or adjusts the duration of the PTW (T_{PTW}) based on one or more parameters related to CCA procedures e.g., number (N) of CCA failures during certain time period, maximum allowed number (Nₘₐₓ) of CCA failures during certain time period etc. For example, T_{PTW} may be extended or adjusted based on N and/or Nₘₐₓ.

In another example, the UE adapts one or more procedures during the PTW based on relation between parameters related to the CCA procedure, e.g., based on the relation between N and Nₘₐₓ, For example, if N>Nₘₐₓ during certain time period, then the UE is not required to receiving paging during that PTW and/or is not required to perform measurements during the PTW.

In general, adapting one or more procedures may comprise adapting one or more parameters, e.g., associated to the procedure/s and/or on which the procedure/s are based. Adapting a procedure, and/or adapting a parameter, may comprise setting the procedure and/or parameter, and/or determining the procedure and/or parameter, and/or performing the procedure based on one or more adapted parameters. Adapting a parameter or procedure may comprise and/or be based on a base procedure being adapted and/or changed; however, adapting a procedure or parameter based on X (e.g., one or more parameters and/or conditions) may refer to the procedure and/or parameter being based on X. For example, adapting a PTW or PTW parameter based on CCA may refer to the PTW or PTW parameter being based on CCA.

A second variant pertains to method in a network node (NW) (e.g., base station) of determining paging window (e.g., PTW) of an eDRX cycle for a UE based on one or more parameters related to the CCA procedure in a cell (e.g., cell1), and may use the determined paging window for performing one or more radio operations. Examples of radio operations are, not transmitting paging related signals in the PTW if the RS (e.g. SSB) associated with the paging occasion is not transmitted due to the CCA failure, deferring or delaying or postponing the transmission of the paging related signals in a paging occasion occurring in the next PTW of the eDRX cycle, deferring or delaying or postponing the transmission of the paging related signals in a paging occasion occurring in the extended part of the PTW e.g. if the PTW is extended due to CCA failure etc.

Approaches described herein allow UE behavior for measurement on a cell of a carrier subject to CCA when also configured with eDRX cycle to be well defined.

It may be considered that the PTW of the eDRX cycle may be adapted or adjusted with and/or based on one or more CCA related parameters. This in turn enables the UE to receive paging in later DRX cycle within the PTW even if there are CCA failures in the PTW.

In some variants, the UE mobility performance in idle and inactive states may be enhanced since the adaptation of the PTW allows the UE to obtain sufficient samples for measurements even if there are CCA failures in the PTW.

Improved power saving for a UE configured with eDRX may be provided as the UE measurement behavior when operating on unlicensed carrier is defined.

In this disclosure, a term node may be used which can be a radio node like a network node or a wireless device or user equipment (UE). Examples of network nodes are NodeB, base station (BS), multi-standard radio (MSR) radio node such as MSR BS, eNodeB, gNodeB, MeNB, SeNB, location measurement unit (LMU), integrated access backhaul (IAB) node, network controller, radio network controller (RNC), base station controller (BSC), relay, donor node controlling relay, base transceiver station (BTS), Central Unit (e.g. in a gNB), Distributed Unit (e.g. in a gNB), Baseband Unit, Centralized Baseband, C-RAN, access point (AP), transmission points, transmission nodes, transmission reception point (TRP), RRU, RRH, nodes in distributed antenna system (DAS), core network node (e.g. MSC, MME etc), O&M, OSS, SON, positioning node (e.g. E-SMLC), etc. The non-limiting term UE or wireless device (WD) may refer to any type of wireless device communicating with a network node and/or with another UE in a cellular or mobile communication system. Examples of UE are target device, device to device (D2D) UE, vehicular to vehicular (V2V), machine type UE, MTC UE or UE capable of machine to machine (M2M) communication, PDA, tablet, mobile terminals, smart phone, laptop embedded equipment (LEE), laptop mounted equipment (LME), USB dongles etc. The term radio access technology, or RAT, may refer to any RAT, e.g., UTRA, E-UTRA, narrow band internet of things (NB-IoT), WiFi, Bluetooth, next generation RAT, New Radio (NR), 4G, 5G, etc. Any of the equipment denoted by the term node, network node or radio network node may be capable of supporting a single or multiple RATs.

The term signal or radio signal used herein can be any physical signal or physical channel. Examples of DL physical signals are reference signal (RS) such as PSS, SSS, CSI-RS, DMRS signals in SS/PBCH block (SSB), discovery reference signal (DRS), CRS, PRS etc. RS may be periodic, e.g., RS occasion carrying one or more RSs may occur with certain periodicity, e.g., 20 ms, 40 ms etc. The RS may also be aperiodic. Each SSB carries NR-PSS, NR-SSS and NR-PBCH in 4 successive symbols. One or multiple SSBs are transmit in one SSB burst which is repeated with certain periodicity e.g. 5 ms, 10 ms, 20 ms, 40 ms, 80 ms and 160 ms. The UE is configured with information about SSB on cells of certain carrier frequency by one or more SS/PBCH block measurement timing configuration (SMTC) configurations. The SMTC configuration comprising parameters such as SMTC periodicity (T_{SMTC}), SMTC occasion length in time or duration, SMTC time offset wrt reference time (e.g. serving cell's SFN) etc. Therefore, SMTC occasion may also occur with certain periodicity e.g. 5 ms, 10 ms, 20 ms, 40 ms, 80 ms and 160 ms. Examples of UL physical signals are reference signal such as SRS, DMRS etc. The term physical channel refers to any channel carrying higher layer information e.g. data, control etc. Examples of physical channels are PBCH, NPBCH, PDCCH, PDSCH, sPUCCH, sPDSCH. sPUCCH. SPUSCH, MPDCCH, NPDCCH, NPDSCH, E-PDCCH, PUSCH, PUCCH, NPUSCH etc.

UE measurements may be performed by the UE on the serving cell as well as on one or more neighbour cells over some known reference symbols or pilot sequences e.g. CRS, SSS, PSS, DRS, SSB, CSI-RS, TRS, etc. The measurements may be done on cells on an intra-frequency carrier, inter-frequency carrier(s) as well as on inter-RAT carriers(s) (depending upon the UE capability whether it supports that RAT).

The measurements may be done on the carrier frequency, e.g. received power on a carrier, RSSI etc. The measurements may be done in low activity RRC states (e.g. RRC idle, RRC inactive) as well as in high activity RRC state (e.g. RRC connected). The measurements are done for various purposes. Some example measurement purposes are: mobility, positioning, self-organizing network (SON), minimization of drive tests (MDT), operation and maintenance (O&M), network planning and optimization beam management, radio link monitoring, etc. Examples of measurements are cell identification (e.g. PCI acquisition), Reference Symbol Received Power (RSRP), Reference Symbol Received Quality (RSRQ), cell global ID (CGI) acquisition, Reference Signal Time Difference (RSTD), SFN and frame time difference (SFTD), UE RX-TX time difference measurement, Radio Link Monitoring (RLM), which consists of Out of Synchronization (out of sync) detection and In Synchronization (in-sync) detection, L1-RSRP for or link recovery procedure or beam management, detection of RS or beam index or identifier, etc. The RS or beams may be addressed or configured by an identifier, which can indicate the location of the beam in time in beam pattern, e.g., beam index such as SSB index indicate SSB beam location in the pre-defined SSB format/pattern. CSI measurements performed by the UE are used for scheduling, link adaptation etc. by network. Examples of CSI measurements or CSI reports are CQI, PMI, RI etc. They may be performed on reference signals like CRS, CSI-RS or DMRS. The measurements can be done with gaps or without gaps (if UE supports this capability).

The term time resource used herein may correspond to any type of physical resource or radio resource expressed in terms of length of time. Examples of time resources are: symbol, time slot, subframe, radio frame, TTI, interleaving time, slot, sub-slot, mini-slot, system frame number (SFN) cycle, hyper-SFN (H-SFN) cycle etc.

The term clear channel assessment (CCA) used herein may correspond to any type of carrier sense multiple access (CSMA) procedure or mechanism which is performed by the device on a carrier before deciding to transmit signals on that carrier. The term carrier may also be interchangeably called as carrier frequency, frequency layer, a channel, a radio channel, a radio frequency channel etc. The CCA is also interchangeably called CSMA scheme, channel assessment scheme, listen-before-talk (LBT), shared channel access mechanism or scheme, shared spectrum channel access mechanism or scheme etc. The frequency band of a carrier subject to CCA may also be called as unlicensed band or spectrum, shared spectrum channel access band, band for operation with shared spectrum channel access etc. The CCA based operation may more generally be called contention-based operation. The transmission of signals on a carrier subjected to CCA is also called contention-based transmission. The contention-based operation is typically used for transmission on carriers of unlicensed frequency band. But this mechanism may also be applied for operating on carriers belonging to licensed band for example to reduce interference. The transmission of signals on a carrier which is not subjected to CCA is also called contention free transmission. LBT or CCA procedure can be performed by UE prior to UL transmission) and/or by a network node (e.g., base station) prior to DL transmission. Therefore, CCA may also be called as DL CCA (e.g., performed by the BS before DL transmission), UL CCA (e.g. performed by the UE before UL transmission) etc.

In an example scenario, a UE configured to operate a signal between the UE and a first cell (cell1) wherein the operation of the signal is subject to CCA. Cell1 may operate or belong to a first carrier frequency (F1). Cell1 may be the serving cell or non-serving cell of the UE. Cell1 may further be served by or operated by a first network node (NW1). The UE may further be configured to operate a signal between the UE and a second cell (cell2). Cell2 may operate or belonging to F1 or to a second carrier frequency (F2). Cells on F2 may or may not be subject to CCA. Cell2 may be served by or operated by NW1 or by a second network node (NW2).

The UE may further be configured with a eDRX cycle (e.g. 5.12 seconds or longer) via higher layers e.g. via core network such as via NAS (Non-Access Stratum) signaling. In one example for a UE operating in RRC_INACTIVE state, the eDRX cycle is configured via RRC signaling by NW1 when the UE is in RRC_CONNECTED state. In another example for a UE operating in RRC_IDLE state, the eDRX cycle may be configured via NAS signaling when the UE is in RRC_CONNECTED state. The UE may further be configured with at least one DRX cycle (e.g., 1.28 seconds) via higher layers, e.g., via RRC signaling. The UE may be operating in low activity state. Examples of low activity states are RRC IDLE state, RRC INACTIVE state etc.

The term “operation of the signal being subject to CCA” may refer to a scenario in which the device before transmitting a signal in cell1 may apply CCA procedure to decide whether the channel is idle or busy, in particular it may transmit the signal if the channel is idle, otherwise it defers the transmission. In the uplink the UE applies CCA before transmission. Therefore, the UE can determine that CCA has failed (or CCA failure has occurred) in the uplink if the UE is unable to transmit a signal due to CCA failure in the uplink. The receiving device (e.g., UE) may further determine whether the signal was transmitted or not by the transmitting device (e.g. BS). For example, the UE may determine based on one or more of the following principles:

Autonomous determination by the UE: The UE can determine that CCA has failed in the downlink (e.g., in the base station transmitting the signal) if the UE is unable to receive a signal or if the signal is unavailable at the UE or the UE determines that the signal is not present or it cannot be detected by the UE. For example, the UE may correlate the signal with pre-defined sequences, e.g., correlating the SSB expected to be received in certain time-frequency resources with one or more candidate SSBs. If the output or result of the correlation is below certain threshold (Ψ) then the UE assumes that the signal (e.g., SSB) was not transmitted by the base station due to DL CCA failure. Otherwise, if the output or result of the correlation is equal to above Ψ then the UE assumes that the signal (e.g., SSB) was transmitted by the base station, e.g., that DL CCA was successful.

Explicit indication from network node: In another example, the network node (e.g., base station) may transmit the results or outcome of the DL CCA failures to the UE. For example, the BS may transmit the outcome or results of the DL CCA in the BS in the last Z1 number of time resources or signals in terms of bitmap to the UE. Each bit may indicate whether the CCA was failure or successful. For example, 0 and 1 in a bitmap may indicate that DL CCA was failure and successful respective respectively.

The term operating a signal (or signalling) is a generic term which may refer to communicating based on and/or utilising the signal or signalling, and/or may comprise transmitting the signal (e.g., UE transmitting the signal to cell1) and/or receiving the signal. In one specific example the operating the signal many comprises performing a measurement on a signal (e.g., UE receiving the signal from and/or transmitting the signal to cell1 used for the measurement). Each occurrence of the signal or the occurrence when the UE can operate the signal is broadly called as an occasion, which may be transmission occasion or a reception occasion. The occasion is also interchangeably called as signal occasion, signal operational occasion, measurement occasion, signal operational opportunity, signal duration, operational occasion or simply occasion for operating a signal etc. Examples of occasions are time resources containing RS (e.g. CSI-RS, SSB), SMTC occasion, discovery burst transmission (DBT) window etc.

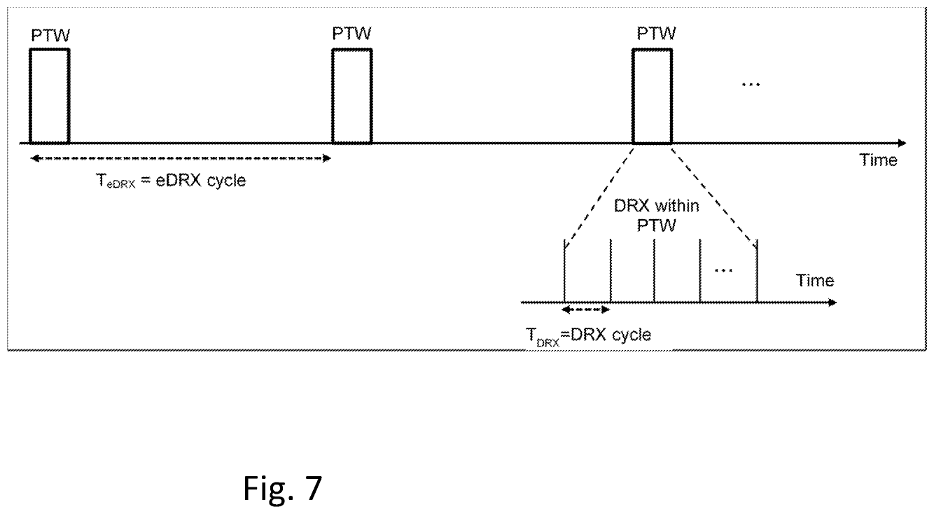

A paging time window (PTW) may occur once every eDRX cycle as shown in FIG. 7. The UE may be configured with, and/or for having, a certain number of DRX cycles within each paging window as also shown in FIG. 7. The term PTW may also be called as paging window, paging transmission window etc. The PTW length or duration (T_{PTW}) can be expressed in terms of suitable time units e.g. Z1 seconds, number of DRX cycles (N1), number (N2) of minimum PTW period (Tₘᵢₙ), in time resources (e.g. slots, frames, SFN cycles) etc. Examples of Tₘᵢₙ are 0.64 second, 1.28 second etc. The term PTW is used hereinafter for consistency.

A method in UE of adapting procedures associated with eDRX when configured with carrier frequency subject to CCA may be considered, as may a correspondingly adapted UE. The UE configured to operate signal cell1 belonging to F1 subject to CCA and configured with a eDRX cycle, may adapt one or more radio procedures associated with eDRX cycle and/or may apply and/or perform and/or use the adapted one or more radio procedures. The adaptation of the radio procedure may further depend on one or more parameters associated with CCA procedure or operation. The CCA procedure may be related to one or more cells belonging to F1. Examples of parameters related to the CCA procedures may comprise one or more of:
Results of the CCA procedure in a cell. The results may be expressed in terms of number (N) of CCA failures occurring in a cell during certain time period (TO). The results may also be or alternatively expressed in terms of number of successful CCA occurring in a cell during certain time period (TO). A CCA failure during an occasion may also be expressed as unavailability of signal (e.g. RS) at the UE during that occasion. The number of CCA failures may be consecutive or non-consecutive during TO. In one example N corresponds to number of RS occasions (e.g. SMTC occasions) not transmitted in the cell during TO due to DL CCA failure. In another example, N may correspond to number of RS occasions (e.g. SMTC occasions) not available at the UE in the cell during TO. In one example, N may correspond to number of DRX cycles each with at least one RS occasion (e.g. SMTC occasion) is not transmitted in the cell due to DL CCA failure during TO. In another example, N may correspond to number of DRX cycles each with at least one RS occasion (e.g. SMTC occasion) not available at the UE during TO. The term RS occasion (e.g. SMTC occasion) not available at the UE may further refers to when the RS occasion (e.g. SMTC) contains RS (e.g. SSBs) configured by the BS in a cell (e.g. cell1) on a carrier frequency (e.g. F1) subject to CCA, but the first two successive candidate RS positions (e.g. SSB positions) for the same RS index (e.g. SS/PBCH block index) within the discovery burst transmission window are not available at the UE due to DL CCA failures at the BS during the corresponding detection, measurement, or evaluation period; otherwise the RS occasion (e.g. SMTC occasion) is considered as available at the UE.
Maximum allowed number (Nₘₐₓ) of CCA failures in a cell during TO. Nₘₐₓ may further depend on one or more parameters. Nₘₐₓ may be pre-defined or configured by the network node. Examples of the parameters are DRX cycle length, eDRX cycle length, periodicity of a reference signal (T_{RS}) (e.g. SMTC period, DBT window period, etc). For example, Nₘₐₓ=8 for DRX cycle length (T_{DRX})<1.28 s and Nₘₐₓ=4 for T_{DRX}≥1.28 s.

Examples of the time period (T0) are T1 seconds, certain number of DRX cycles, PTW length or duration in time (T_{PTW}), certain number of time resources (e.g. slots, subframes, frames etc), measurement time (Tm) etc. The measurement time, Tm, may also be expressed in terms of one or more of number of DRX cycle, number of eDRX cycles etc., which may be consecutive or non-consecutive. Examples of measurement time are cell evaluation period, cell identification period, measurement period, cell selection period, cell reselection period etc.

Examples of adaptation of one or more radio procedures associated with eDRX cycle when configured with cell1 are described below:

Adapting PTW length based on parameters related to CCA procedure is considered. In this example, if eDRX length is larger than certain threshold (T) (e.g. T=10.24s), then the PTW design may be applied and/or adapted. The PTW length (T_{PTW}) may be adapted or adjusted by the UE based on one or more parameters related to CCA procedure. The adapted PTW length may be expressed by a function or a relation of at least one parameter related to the CCA procedure. Examples of function are minimum, maximum, sum, product, ratio, xth percentile, ceiling, ratio, floor, or combination of two or more functions (e.g. sum, product etc). The UE may further perform one or more radio procedures during the adapted PTW. Examples of radio procedures are performing one or more measurements (e.g. RSRP, RSRQ, cell search etc), monitoring control channel (e.g. PDCCH) during the control channel monitoring occasions, receiving paging during the paging occasion configured during PTW, evaluating the cell quality etc. The paging reception may comprise for example, the UE tuning its receiver to receive one or more channels associated with paging (e.g. control channel (e.g. PDCCH) and paging data or pay load (e.g. PDSCH) during the configured paging resources etc).

### General Examples of Adapted T_{PTW}

A general example of the adapted T_{PTW} is expressed by (1):

$${T}_{PTW} = f 1 ( {T}_{min} , L 1 , M 1 , N ) \qquad ( 1 )$$

A special case of (1) where M1 is not used is given by (2):

$${T}_{PTW} = f 1 ( {T}_{min} , L 1 , N ) \qquad ( 2 )$$

Another general example of the adapted T_{PTW} is expressed by (3):

$${T}_{PTW} = f 2 ( {T}_{min} , L 1 , M 1 , Nmax ) \qquad ( 3 )$$

A special case of (3) where M1 is not used is given by (4):

$${T}_{PTW} = f 2 ( {T}_{min} , L 1 , Nmax ) \qquad ( 4 )$$

Another general example of the adapted T_{PTW} is expressed by (5):

$${T}_{PTW} = f 3 ( {T}_{min} , L 1 , M 1 , g 1 ( N , {N}_{max} ) ) \qquad ( 5 )$$

A special case of (5) where M1 is not used is given by (6):

$${T}_{PTW} = f 3 ( {T}_{min} , L 1 , g 1 ( N , {N}_{max} ) ) \qquad ( 6 )$$

Another general example of the adapted T_{PTW} is expressed by (7):

$${T}_{PTW} = f 4 ( {T}_{min} , {T}_{PTW 0} , M 1 , N ) \qquad ( 7 )$$

A special case of (7) where M1 is not used is given by (8):

$${T}_{PTW} = f 4 ( {T}_{min} , {T}_{PTW 0} , N ) \qquad ( 8 )$$

Another general example of the adapted T_{PTW} is expressed by (9):

$${T}_{PTW} = f 5 ( {T}_{min} , {T}_{PTW 0} , M 1 , {N}_{max} ) \qquad ( 9 )$$

A special case of (9) where M1 is not used is given by (10):

$${T}_{PTW} = f 5 ( {T}_{min} , {T}_{PTW 0} , {N}_{max} ) \qquad ( 10 )$$

Another general example of the adapted T_{PTW} is expressed by (11):

$${T}_{PTW} = f 6 ( {T}_{min} , {T}_{PTW 0} , M 1 , g 2 ( N , {N}_{max} ) ) \qquad ( 11 )$$

A special case of (11) where M1 is not used is given by (12):

$${T}_{PTW} = f 6 ( {T}_{min} , {T}_{PTW 0} , g 2 ( N , {N}_{max} ) ) \qquad ( 12 )$$

Where the parameters are described below:
Tₘᵢₙ: is minimum or basic or smallest period. T_{PTW} is expressed in terms of number of Tₘᵢₙ periods.
L1: is a scaling factor. For example L1>0. In one example L1=2. L1 may further depend on the length of DRX cycle (T_{DRX}) and/or length of eDRX cycle (T_{eDRX}). In one example L1 may be a baseline scaling factor e.g. scaling used when the carrier is not subject to CCA.
M1: is another scaling factor which depends on one or more of: T_{DRX} configured in PTW, T_{RS} (e.g. SMTC period (T_{SMTC})) of the RS (e.g. SSB, SMTC etc) configured for measurements on at least cell1 etc. In one example M1=2 if T_{SMTC}>certain threshold (H1) and if T_{DRX}≤certain threshold (H2); otherwise M1=1. Examples of H1 and H2 are 20 ms and 640 ms respectively. In another example M1=1 regardless of T_{DRX} and/or T_{RS}. The last example may further imply that M1 is not used or T_{PTW} is not scaled by M1.
T_{PTW0}: is the PTW length configured for a cell which is not subject to CCA e.g. for a cell on a carrier of licensed band or band which does not belong to a shared spectrum channel access.

Specific examples of adapted T_{PTW} are provided in the following. Specific examples of the adapted T_{PTW} based on or derived from general expressions (1-12) are given below:

One specific example of the adapted T_{PTW} corresponding to the general expression in (1), is expressed by (13):

$${T}_{PTW} = {T}_{min} * M 1 * ( L 1 + N ) \qquad ( 13 )$$

Above expression may further be expressed with an example shown in table 1. In this example, the parameter L1 depends on DRX cycle e.g. L1={I₁₁, I₁₂, I₁₃ and I₁₄} for DRX cycles T_{DRX}={T_{DRX,1}, T_{DRX,2}, T_{DRX,3}, T_{DRX,4}} respectively. The parameter M1 depends on DRX cycle and T_{RS} e.g. M1={m₁₁, m₁₂, m₁₃ and m₁₄} for DRX cycles T_{DRX}={T_{DRX,1}, T_{DRX,2}, T_{DRX,3}, T_{DRX,4}} respectively. The measurement time may be scaled by another scaling factor e.g. K where K={k₁₁, k₁₂, k₁₃ and k₁₄} for DRX cycles TORX={T_{DRX,1}, T_{DRX,2}, T_{DRX,3}, T_{DRX,4}} respectively. An example for specific DRX cycles T_{DRX}={0.32 s, 0.64 s, 1.28 s, 2.56 s} and scaling factors is shown in table 2. One set of examples of T_{eDRX_min} and T_{eDRX_max} are 20.48 seconds and 10485.76 seconds respectively. Another set of examples of T_{eDRX_min} and T_{eDRX_max} are 5.12 seconds and 10485.76 seconds respectively.

Another specific example of the adapted T_{PTW} corresponding to the general expression in (2), is expressed by (14):

$${T}_{PTW} = {T}_{min} * ( L 1 + N ) \qquad ( 14 )$$

In the above example the PTW length and measurement time may not be further scaled by M1 e.g. M1=1 i.e. m₁₁=m₁₂=m₁₃=m₁₄=1. An example with M1=1 (i.e. no scaling by M1) for specific DRX cycles and scaling factors is shown in table 3.

TABLE 1
An example of PTW length as function of number (N) of CCA failures during time period T0

| eDRX | DRX cycle | PTW | Scaling | Measurement time (Tm) (s) | |
|---|---|---|---|---|---|
| cycle | length | length | factor | Tm | Number of |
| length [s] | (T_{DRX}) [s] | [s] | (M1) | (seconds) | DRX cycles |
| T_{eDRX}_{_{—}}ₘᵢₙ ≤ | T_{DRX, 1} | ≥Tₘᵢₙ *m₁₁*(I₁₁ + | m₁₁ | T_{DRX, 1} *m₁₁*(k₁₁ + | m₁₁*(k₁₁ + N) |
| T_{eDRX} ≤ | | N) | | N) | |
| T_{eDRX}_{_{—}}ₘₐₓ | T_{DRX, 2} | ≥Tₘᵢₙ *m₁₂*(I₁₂ + | m₁₂ | T_{DRX, 1} *m₁₂*(k₁₂ + | m₁₂*(k₁₂ + N) |
| | | N) | | N) | |
| | T_{DRX, 3} | ≥Tₘᵢₙ *m₁₃*(I₁₃ + | m₁₃ | T_{DRX, 1}*m₁₃*(k₁₃ + | m₁₃*(k₁₃ + N) |
| | | N) | | N) | |
| | T_{DRX, 4} | ≥Tₘᵢₙ *m₁₄*(I₁₄ + | m₁₄ | T_{DRX, 1} *m₁₄*(k₁₄ + | m₁₄*(k₁₄ + N) |
| | | N) | | N) | |

TABLE 2
A specific example of PTW length as function of number (N) of CCA failures during time period T0

| | DRX | | | | | |
|---|---|---|---|---|---|---|
| eDRX | cycle | | Scaling | | | |
| cycle | length | | factor (M1) | | Measurement time (Tm) (s) | |
| length | (T_{DRX}) | PTW | T_{RS} ≤ | T_{RS} > | Tm | Number of |
| [s] | [s] | length [s] | H1 | H1 | (seconds) | DRX cycles |
| T_{eDRX}_{_{—}}ₘᵢₙ ≤ | 0.32 | ≥Tₘᵢₙ *m₁₁*(l₁₁ + N) | 1 | 2 | 0.32 *m₁₁*(k₁₁ + N) | m₁₁*(k₁₁ + N) |
| T_{eDRX} ≤ | 0.64 | ≥Tₘᵢₙ *m₁₂*(l₁₂ + N) | 1 | 2 | 0.64*m₁₂*(k₁₂ + N) | m₁₂*(k₁₂ + N) |

| | | | | | |
|---|---|---|---|---|---|
| T_{eDRX}_{_{—}}ₘₐₓ | 1.28 | ≥Tₘᵢₙ *m₁₃*(l₁₃ + N) | 1 | 1.28*(k₁₃ + N) | (k₁₃ + N) |
| | 2.56 | ≥Tₘᵢₙ *m₁₄*(l₁₄ + N) | 1 | 2.56*(k₁₄ + N) | (k₁₄ + N) |

TABLE 3
A specific example of PTW length as function of
number (N) of CCA failures during time period T0

| eDRX | DRX cycle | PTW | Measurement time (Tm) (s) | |
|---|---|---|---|---|
| cycle | length | length | Tm | Number of |
| length [s] | (T_{DRX}) [s] | [s] | (seconds) | DRX cycles |
| T_{eDRX}_{_{—}}ₘᵢₙ ≤ | 0.32 | ≥Tₘᵢₙ*(I₁₁ + | 0.32*(k₁₁ + | (k₁₁ + N) |
| T_{eDRX} ≤ | | N) | N) | |
| T_{eDRX}_{_{—}}ₘₐₓ | 0.64 | ≥Tₘᵢₙ*(I₁₂ + | 0.64*(k₁₂ + | (k₁₂ + N) |
| | | N) | N) | |
| | 1.28 | ≥Tₘᵢₙ*(I₁₃ + | 1.28*(k₁₃ + | (k₁₃ + N) |
| | | N) | N) | |
| | 2.56 | ≥Tₘᵢₙ*(I₁₄ + | 2.56*(k₁₄ + | (k₁₄ + N) |
| | | N) | N) | |

Another specific example of the adapted T_{PTW} corresponding to the general expression in (3), is expressed by (15):

$${T}_{PTW} = {T}_{min} * M 1 * ( L 1 + {N}_{max} ) \qquad ( 15 )$$

The above expression may further be expressed with an example shown in table 4. In this example, the parameter L1 may also depend on DRX cycle e.g. L1={I₁₁, I₁₂, I₁₃ and I₁₄} for DRX cycles T_{DRX}={T_{DRX,1}, T_{DRX,2}, T_{DRX,3}, T_{DRX,4}} respectively. The parameter M1 depends on DRX cycle and T_{RS} e.g. M1={m₁₁, m₁₂, m₁₃ and m₁₄} for DRX cycles T_{DRX}={T_{DRX,1}, T_{DRX,2}, T_{DRX,3}, T_{DRX,4}} respectively. The measurement time (Tm) may be scaled by another scaling factor e.g. K where K={k₁₁, k₁₂, k₁₃ and k₁₄} for DRX cycles T_{DRX}={T_{DRX,1}, T_{DRX,2}, T_{DRX,3}, T_{DRX,4}} respectively. An example for specific DRX cycles, T_{DRX}={0.32 s, 0.64 s, 1.28 s, 2.56 s} and scaling factors is shown in table 5.

Another specific example of the adapted T_{PTW} corresponding to the general expression in (4), is expressed by (16):

$${T}_{PTW} = {T}_{min} * ( L 1 + {N}_{max} ) \qquad ( 16 )$$

In the above example in (16), the PTW length and the measurement time may not be further scaled by M1 e.g. M1=1 i.e. m₁₁=m₁₂=m₁₃=m₁₄=1. An example with M1=1 (i.e. no scaling by M1) for specific DRX cycles and scaling factors is shown in table 6.

TABLE 4
An example of PTW length as function of maximum allowed
number (Nₘₐₓ) of CCA failures during time period T0

| | | | | Measurement time (Tm) (s) | |
|---|---|---|---|---|---|
| eDRX | DRX cycle | PTW | Scaling | | Number of |
| cycle | length | length | factor | Tm | DRX cycles |
| length [s] | (T_{DRX}) [s] | [s] | (M1) | (seconds) | (Nₛₑᵣᵥ) |
| T_{eDRX}_{_{—}}ₘᵢₙ ≤ | T_{DRX, 1} | ≥Tₘᵢₙ *m₁₁*(I₁₁ + | m₁₁ | T_{DRX, 1} *m₁₁*(k₁₁ + | m₁₁*(k₁₁ + N) |
| T_{eDRX} ≤ | | Nₘₐₓ) | | N) | |
| T_{eDRX}_{_{—}}ₘₐₓ | T_{DRX, 2} | ≥Tₘᵢₙ *m₁₂*(I₁₂ + | m₁₂ | T_{DRX, 1} *m₁₂*(k₁₂ + | m₁₂*(k₁₂ + N) |
| | | Nₘₐₓ) | | N) | |
| | T_{DRX, 3} | ≥Tₘᵢₙ *m₁₃*(I₁₃ + | m₁₃ | T_{DRX, 1}*m₁₃*(k₁₃ + | m₁₃*(k₁₃ + N) |
| | | Nₘₐₓ) | | N) | |
| | T_{DRX, 4} | ≥Tₘᵢₙ *m₁₄*(I₁₄ + | m₁₄ | T_{DRX, 1} *m₁₄*(k₁₄ + | m₁₄*(k₁₄ + N) |
| | | Nₘₐₓ) | | N) | |

TABLE 5
A specific example of PTW length as function of maximum allowed
number (Nₘₐₓ) of CCA failures during time period T0

| | DRX | | | | | |
|---|---|---|---|---|---|---|
| eDRX | cycle | | Scaling | | Measurement time (Tm) (s) | |
| cycle | length | | factor (M1) | | | Number of |
| length | (T_{DRX}) | PTW | T_{RS} ≤ | T_{RS} > | | DRX cycles |
| [s] | [s] | length [s] | H1 | H1 | Tm (seconds) | (Nₛₑᵣᵥ) |
| T_{eDRX}_{_{—}}ₘᵢₙ ≤ | 0.32 | ≥Tₘᵢₙ *m₁₁*(l₁₁ + N) | 1 | 2 | 0.32 *m₁₁*(k₁₁ + N) | m₁₁*(k₁₁ + N) |
| T_{eDRX} ≤ | 0.64 | ≥Tₘᵢₙ *m₁₂*(l₁₂ + N) | 1 | 2 | 0.64*m₁₂*(k₁₂ + N) | m₁₂*(k₁₂ + N) |

| | | | | | |
|---|---|---|---|---|---|
| T_{eDRX}_{_{—}}ₘₐₓ | 1.28 | ≥Tₘᵢₙ *m₁₃*(l₁₃ + N) | 1 | 1.28*(k₁₃ + N) | (k₁₃ + N) |
| | 2.56 | ≥Tₘᵢₙ *m₁₄*(l₁₄ + N) | 1 | 2.56*(k₁₄ + N) | (k₁₄ + N) |

TABLE 6
A specific example of PTW length as function of maximum allowed
number (Nmax) of CCA failures during time period T0

| eDRX | DRX cycle | PTW | Measurement time (Tm) (s) | |
|---|---|---|---|---|
| cycle | length | length | Tm | Number of |
| length [s] | (T_{DRX}) [s] | [s] | (seconds) | DRX cycles |
| T_{eDRX}_{_{—}}ₘᵢₙ ≤ | 0.32 | ≥Tₘᵢₙ *(I₁₁ + | 0.32*(k₁₁ + | (k₁₁ + N) |
| T_{eDRX} ≤ | | Nₘₐₓ) | N) | |
| T_{eDRX}_{_{—}}ₘₐₓ | 0.64 | ≥Tₘᵢₙ *(I₁₂ + | 0.64*(k₁₂ + | (k₁₂ + N) |
| | | Nₘₐₓ) | N) | |
| | 1.28 | ≥Tₘᵢₙ *(I₁₃ + | 1.28*(k₁₃ + | (k₁₃ + N) |
| | | Nₘₐₓ) | N) | |
| | 2.56 | ≥Tₘᵢₙ *(I₁₄ + | 2.56*(k₁₄ + | (k₁₄ + N) |
| | | Nₘₐₓ) | N) | |

Another specific example of the adapted T_{PTW} corresponding to the general expression in (5), is expressed by (17):

$${T}_{PTW} = {T}_{min} * M 1 * ( L 1 + N + {N}_{max} ) \qquad ( 17 )$$

Another specific example of the adapted T_{PTW} corresponding to the general expression in (6), is expressed by (18):

$${T}_{PTW} = {T}_{min} * ( L 1 + N + {N}_{max} ) \qquad ( 18 )$$

Another specific example of the adapted T_{PTW} corresponding to the general expression in (7), is expressed by (19):

$${T}_{PTW} = ( {T}_{PTW 0} + {T}_{min} * M 1 * N ) \qquad ( 19 )$$

Another specific example of the adapted T_{PTW} corresponding to the general expression in (8), is expressed by (20):

$${T}_{PTW} = ( {T}_{PTW 0} + {T}_{min} * N ) \qquad ( 20 )$$

Another specific example of the adapted T_{PTW} corresponding to the general expression in (9), is expressed by (21):

$${T}_{PTW} = ( {T}_{PTW 0} + {T}_{min} * {N}_{max} ) \qquad ( 21 )$$

Another specific example of the adapted T_{PTW} corresponding to the general expression in (10), is expressed by (22):

$${T}_{PTW} = ( {T}_{PTW 0} + {T}_{min} * {N}_{max} ) \qquad ( 22 )$$

Another specific example of the adapted T_{PTW} corresponding to the general expression in (11), is expressed by (23):

$${T}_{PTW} = ( {T}_{PTW 0} + {T}_{min} * M 1 * ( N + {N}_{max} ) ) \qquad ( 23 )$$

Another specific example of the adapted T_{PTW} corresponding to the general expression in (12), is expressed by (24):

$${T}_{PTW} = ( {T}_{PTW 0} + {T}_{min} * ( N + {N}_{max} ) ) \qquad ( 24 )$$

Adapting UE procedures in PTW based on parameters related to CCA procedure is described exemplarily. In an example, the adaptation of one or more radio procedures associated with eDRX cycle may be triggered based on at least a relation between parameters related to the CCA procedure e.g. based on the relation between N and Nₘₐₓ. Examples of the adapted procedures are:
In one example, if (N>Nₘₐₓ) occurs R1 number of times during the measurement period (T0), then the UE may not be required to or is not expected to perform measurements on one or more cells (e.g. on cell1, cell2 etc) during the PTW duration (T_{PTW}). Otherwise, the UE is required to perform measurements on the one or more cells at least during the PTW. The parameter, R1, can be pre-defined or configured by the network node. R1 may further depend on one or more of: Tₘᵢₙ, T_{PTW}, T_{DRX}, T_{eDRX} etc. In one example R1=1. In another example, R2=2.
In another example, if (N>Nₘₐₓ) occurs R2 number of times during the measurement period (T0) then the UE is not required to or is not expected to receive paging during the PTW. Otherwise, the UE is required to receive paging during the PTW duration (T_{PTW}). The parameter, R2, can be pre-defined or configured by the network node. R2 may further depend on one or more of: Tₘᵢₙ, T_{PTW}, T_{DRX}, T_{eDRX}, number of control channel (e.g. PDCCH) monitoring occasions associated with the paging occasion etc. In one example R2=1. In another example, R2=2. In another example, R1=R2. In another example, R1+R2.
In another example, if (N>Nₘₐₓ) occurs R3 number of times during the measurement period (T0) then the UE may extend or is allowed to extend or is required to extend the PTW duration (T_{PTW}) by certain duration e.g. by G1*Tₘᵢₙ. Otherwise, the UE is not required to extend the PTW duration (T_{PTW}). The extended PTW duration (T_{PTW-E}) can be expressed as T_{PTW-E}=T_{PTW}+G1*Tₘᵢₙ. In one example, T_{PTW}=T_{PTW0}. In another example, T_{PTW} is the PTW duration adapted based on one or more parameters related to the CCA related procedure e.g. as expressed by (1-12) in examples in section 6.1.3.1. The parameters, G1 and R3, can be pre-defined or configured by the network node. G1 and R3 may further depend on one or more of: Tₘᵢₙ, T_{PTW}, T_{DRX}, T_{eDRX}, number of control channel monitoring occasions associated with the paging occasion etc. In one example R3=1. In another example, R3=2. In another example, R1=R2=R3. In another example, R1≠R2≠R3.
In another example, if (N>Nₘₐₓ) occurs R4 number of times during the measurement period (T0) then the UE may restart the PTW. Otherwise, the UE is not required to restart the PTW. In one example the PTW duration after the restarting may be the same as before. In another example the PTW duration after the restarting may be extended by certain duration e.g. by G2*Tₘᵢₙ. The parameters, G2 and R4, can be pre-defined or configured by the network node. G2 and R4 may further depend on one or more of: Tₘᵢₙ, T_{PTW}, T_{DRX}, T_{eDRX}, number of control channel monitoring occasions associated with the paging occasion etc. In one example R4=1. In another example, R4=2. In another example, R1=R2=R3=R4. In another example, R1≠R2≠R3≠R4.
In yet another example, if (N>Nₘₐₓ) occurs R5 number of times during the measurement period (T0) then the UE may adapt one or more parameters related to the eDRX configuration. In one example, the UE switches from using an eDRX configuring based on PTW to an eDRX configuration without PTW when (N>Nₘₐₓ) occurs R5 times i.e. UE may measure and receive paging also outside the PTW. Otherwise, the UE continues using the current eDRX configuration i.e. measures and receives paging within PTW. The reason is that when the number CCA failures are high, then it is better for the UE to measure more frequently every Q1^{th} eDRX cycle, e.g. Q1=1, 2, etc. The value of R5 can be predefined or configured. In one example R5=1.
In yet another example, if (N>Nₘₐₓ) occurs R6 number of times during the measurement period (TO) then the UE may stop using an eDRX cycle and switch to a legacy DRX configuration, and may further start using legacy DRX cycle for one or more operations e.g. UE may measure every Q2^{th} DRX cycle and may receive paging at least once every paging cycle e.g. Q2=1, 2 etc. Otherwise (i.e. if (N>Nₘₐₓ) occurs less than R6 times), then the UE continues using the eDRX configuration i.e. measures and receives paging within PTW. The value of R6 can be predefined or configured. In one example, R6=1.

Adapting UE procedures when configured with carrier subject to CCA as well as with carrier not subject to CCA are described. In an example, the adaptation of one or more radio procedures associated with eDRX cycle may be triggered based whether the UE is configured with at least one carrier (F1) subject to CCA and at least another carrier (F2) which is not subject to CCA. The adaptation may further depend on whether cell1 is the serving cell or a non-serving cell of the UE. Examples of the adapted procedures are:
In one example, if the UE is configured with at least F1 and F2 and with eDRX cycle, then the UE is required to perform measurements on at least one cell of F1 and at least one cell of F2 during at least the PTW duration.
In another example, if the UE is configured with at least F1 and F2 and with eDRX cycle, then the UE is required to perform measurements on at least one cell of F1 during at least the PTW duration but is not required to perform measurements on the cells of F2 during the PTW duration. In this case the UE may be required to perform the measurements on cells of F2 every P1th DRX cycle. In one example P1=1. In another example P1=2 etc. This rule may be expressed as that when the UE is configured with F1 and F2 then the UE is required to perform measurements on cells of F1 based on eDRX cycle and measurements on cells of F2 based on DRX cycle. This rule may also be expressed as that when the UE is configured with F1 and F2 then the UE is required to perform measurements on cells of F1 while meeting measurement requirements associated with eDRX cycle, and measurements on cells of F2 while meeting measurement requirements associated with DRX cycle.

In general, examples of measurement requirements may comprise one or more of measurement time, measurement sensivity or threshold, number of measurements to be performed, etc. Examples of measurement time are cell evaluation period, cell identification period, measurement period etc. This above rule(s) may further depend on whether the carrier frequency of the serving cell is subject to the CCA. In one example this rue may apply if serving cell is on carrier which is subject to CCA e.g. cell1 is the serving cell. In another example this rue may apply if serving cell is on carrier which is not subject to CCA e.g. cell2 is the serving cell and not subject to CCA.
In another example, if the UE is configured with at least F1 and F2 and with eDRX cycle, then the UE is required to perform measurements on at least one cell of F2 during at least the PTW duration; but is not required to perform measurements on the cells of F1 during the PTW duration. In this case the UE may be required to perform the measurements on cells of F1 every P2th DRX cycle. In one example P2=1. In another example P2=2 etc. This rule may be also be expressed as that when the UE is configured with F1 and F2 then the UE is required to perform measurements on cells of F2 based on eDRX cycle and measurements on cells of F1 based on DRX cycle. This rule may also be expressed as that when the UE is configured with F1 and F2 then the UE is required to perform measurements on cells of F2 while meeting measurement requirements associated with eDRX cycle, and measurements on cells of F1 while meeting measurement requirements associated with DRX cycle. This above rule(s) may further depend on whether the carrier frequency of the serving cell is subject to the CCA. In one example this rue may apply if serving cell is on carrier which is subject to CCA e.g. cell1 is the serving cell. In another example this rue may apply if serving cell is on carrier which is not subject to CCA e.g. cell2 is the serving cell and not subject to CCA.

In another example, if the UE is configured with at least F1 and F2 and with eDRX cycle, then the UE is not required to perform measurements on cells of F1 and on cells of F2 during the PTW duration. In this scenario the UE measurement behaviour may further be defined as e.g.
In one example the UE may be required to perform measurements on cells of F1 and on cells of F2 every P3^{th} DRX cycle and P4^{th} DRX cycle respectively. Examples of P3 and P4 are P3=1, P4=1 and P3=2, P4=2 etc. This rule may be expressed as that when the UE is configured with F1 and F2 and with eDRX cycle, then the UE is not required to meet measurement requirements associated with eDRX cycle.
In another example the UE may be not be required to perform or is not expected to perform any measurements on cells of F1 or on cells of F2. This rule may be expressed as that when the UE is configured with F1 and F2 and with eDRX cycle, then the UE is not required to meet any measurement requirements i.e. neither associated with eDRX cycle nor associated with DRX cycle.

Above rule(s) may further depend on whether the carrier frequency of the serving cell is subject to the CCA. In one example this rue may apply if serving cell is on carrier which is subject to CCA e.g. cell1 is the serving cell. In another example this rue may apply if serving cell is on carrier which is not subject to CCA e.g. cell2 is the serving cell and not subject to CCA.

A method in a network node of determining and using PTW based on parameter(s) related to CCA procedure is described, a correspondingly adapted network node is proposed.

The network node may determine the PTW duration (T_{PTW}), associated with eDRX based on one or more parameters related to the CCA procedure in a cell (e.g. cell1). The CCA related parameters may be the same as described referring to the UE, e.g. N and Nₘₐₓ. The network node may further adapt one or more radio operations or procedures during the adapted PTW of the eDRX cycle. THE PTW duration may be configured to the network node. The network node (e.g. base station) may determine the parameter N by detecting or determining whether the CCA was a failure or success during the occasion in which the RS used by the UE is transmitted. The network node (e.g. base station) may determine the parameter Nₘₐₓ based on one or more of the parameters configured for the UE e.g. the DRX cycle length, eDRX cycle length, RS periodicity (e.g. T_{SMTC}) etc.

The network node (e.g. base station) may determine the PTW duration (T_{PTW}), which may be adapted or adjusted by the UE, using the principles as described referring to UE analogously.

Examples of one or more procedures which can be adapted by the network node during the adapted PTW are:
In one example, the network node may determine whether the RS (e.g. SSB) associated with paging occasion configured for a UE on a cell (e.g. cell1) is transmitted or not transmitted due to the CCA failure during the PTW. If the RS is not transmitted due to CCA failure in cell1 then the UE may adapt transmission of one or more signals related to paging (e.g. control channel related to paging, paging message etc). In one example the network node may not transmit the paging related signals associated with the RS which was not transmitted due to CCA failure in cell1. In another example the network node may defer the transmission of the paging related signals in a paging occasion occurring at a future time. In another example the network node may defer or delay or postpone the transmission of the paging related signals in a paging occasion occurring in the next PTW of the eDRX cycle. In another example the network node may defer or delay or postpone the transmission of the paging related signals in a paging occasion occurring in the extended part of the PTW of the eDRX cycle.
In another example, the network node may determine whether one or more associated with paging occasion configured for a UE on a cell (e.g. cell1) is transmitted or not transmitted due to the CCA failure during the PTW. If the paging related signal is not transmitted due to CCA failure in cell1 then the UE may adapt transmission of one or more signals related to paging (e.g. control channel related to paging, paging message etc). In one example the network node may defer the retransmission of the paging related signals in a paging occasion occurring at a future time. In another example the network node may defer or delay or postpone the retransmission of the paging related signals in a paging occasion occurring in the next PTW of the eDRX cycle. In another example the network node may defer or delay or postpone the retransmission of the paging related signals in a paging occasion occurring in the extended part of the PTW of the eDRX cycle.

It may be considered that the RAN and/or a radio node is operating in an unlicensed frequency band (or carrier or part thereof, also referred to as license-exempt) and/or based on a LBT or channel assessment procedure to access (for transmission) the frequency band (or carrier or part thereof), for example in a License Assisted Access (LAA) operation mode and/or in the context of NR-U (NR unlicensed).

Measurement reporting may be transmitted on, and/or associated to a channel, in particular a physical control channel or data channel, e.g., PUCCH or PUSCH or PSCCH or PSSCH. A feedback radio node may be configured by a signalling radio node, e.g. with higher layer signalling, e.g. MAC layer signalling and/or RRC signalling. In particular, a measurement configuration may be configured with such signalling, e.g. a CLI measurement configuration and/or a RSSI configuration like a RMTC. A signalling radio node may be adapted for transmitting corresponding control signalling and/or may be adapted for transmitting reference signalling as indicated in, and/or according to, a configuration. Measurement reporting may be based on performing one or more measurements, and/or based on one or more reports.

In general, a wireless device and/or network node may operate in, and/or the communication and/or signalling may be in, TDD operation, in particular dynamic TDD, in which a TDD pattern (e.g., indicating UL/DL periods of operation) may be dynamically and/or semi-dynamically indicated, e.g., with physical layer control information like DCI, or with higher layer signalling like MAC signalling.

A wireless device and/or feedback radio node (a wireless device may be considered an example for a feedback radio node), may in general comprise, and/or be adapted to utilise, processing circuitry and/or radio circuitry, in particular a transmitter and/or transceiver and/o receiver, to process (e.g., trigger and/or schedule) and/or transmit and/or receive signalling like data signalling and/or control signalling like acknowledgement signalling and/or reference signalling. In particular, a feedback radio node may be adapted to receive signalling like reference signalling, and/or to perform measurement on received signalling like reference signalling (reference signalling may in general be, for example, synchronisation signalling like PSS and/or SSS, and/or CSI-RS, and/or, SRS, and/or DM-RS, or similar) and/or transmit measurement reporting representative and/or based on measurement. A wireless device or feedback radio node may be implemented as terminal or UE; in some cases, it may however be implemented as network node, in particular a base station or relay node or IAB node, in particular to provide MT (Mobile Termination) functionality for such. In general, a wireless device of feedback radio node may comprise and/or be adapted for transmission diversity, and/or may be connected or connectable to, and/or comprise, antenna circuitry, and/or two or more independently operable or controllable antenna arrays or arrangements, and/or transmitter circuitries and/or antenna circuitries, and/or may be adapted to use (e.g., simultaneously) a plurality of antenna ports (e.g., for transmitting first signalling and second signalling), e.g., controlling transmission using the antenna array/s, and/or to utilise and/or operate and/or control two or more transmission sources, to which it may be connected or connectable, or which it may comprise. The feedback radio node may comprise multiple components and/or transmitters and/or transmission sources and/or TRPs (and/or be connected or connectable thereto) and/or be adapted to control transmission or reception from such. Any combination of units and/or devices able to control transmission on an air interface and/or in radio as described herein may be considered a feedback radio node. In general, a feedback radio node may be a radio node adapted for, and/or capable of, transmitting feedback signalling, in particular acknowledgement signalling, and/or for receiving or being scheduled with subject transmission/s (based on which feedback signalling may be transmitted).

A signalling radio node and/or network node (a network node may be considered an example of a signalling radio node) may comprise, and/or be adapted to utilise, processing circuitry and/or radio circuitry, in particular a receiver and/or transmitter and/or transceiver, to transmit and/or to process and/or receive (e.g., receive and/or demodulate and/or decode and/or perform blind detection and/or schedule or trigger) data signalling and/or control signalling and/or reference signalling, in particular first signalling and second signalling. In some cases, a signalling radio node may be a network node or base station or TRP, or may be an IAB node or relay node, e.g., providing control level functionality for such, e.g., DU and/or CU functionality. In some cases, e.g., sidelink scenarios, a signalling radio node may be implemented as a wireless device or terminal or UE. A signalling radio node or network node may comprise one or more independently operable or controllable receiving or transmitting circuitries and/or antenna circuitries and/or may be adapted to utilise and/or operate to receive from one or more transmission source simultaneously and/or separately (in time domain), and/or to operate using (e.g., receiving or transmitting) two or more antenna ports simultaneously, and/or may be connected and/or connectable and/or comprise multiple independently operable or controllable antennas or antenna arrays or subarrays. A signalling radio node may in general be a radio node adapted for transmitting subject transmission and/or scheduling subject transmission. Subject transmission in particular may be reference signalling.

Receiving may comprise scanning a frequency range (e.g., a carrier) for reference signalling and/or control signalling, e.g., at specific (e.g., predefined and/or configured) locations in time/frequency domain, which may be dependent on the carrier and/or system bandwidth. Such location/s may correspond to one or more location or resource allocations configured or indicated or scheduled or allocated to a feedback radio node, e.g., scheduled dynamically, or configured, e.g., with DCI and/or RRC signalling, e.g., for transmission on resources allocated for data signalling and/or control signalling (e.g., CORESET) and/or reference signalling (e.g., measurement occasions).

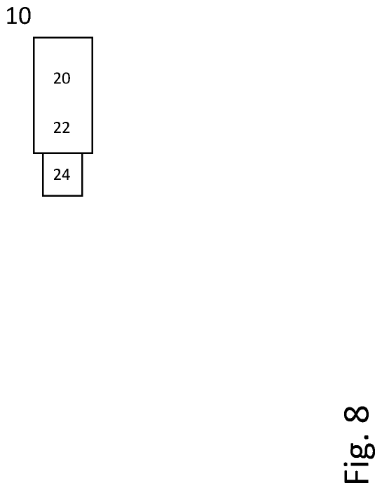

FIG. 8 schematically shows a radio node, in particular a wireless device or terminal 10 or a UE (User Equipment), which may be a REDCAP UE. Radio node 10 comprises processing circuitry (which may also be referred to as control circuitry) 20, which may comprise a controller connected to a memory. Any module of the radio node 10, e.g., a communicating module or determining module, may be implemented in and/or executable by, the processing circuitry 20, in particular as module in the controller. Radio node 10 also comprises radio circuitry 22 providing receiving and transmitting or transceiving functionality (e.g., one or more transmitters and/or receivers and/or transceivers), the radio circuitry 22 being connected or connectable to the processing circuitry. An antenna circuitry 24 of the radio node 10 is connected or connectable to the radio circuitry 22 to collect or send and/or amplify signals. Radio circuitry 22 and the processing circuitry 20 controlling it are configured for cellular communication with a network, e.g., a RAN as described herein, and/or for sidelink communication (which may be within coverage of the cellular network, or out of coverage; and/or may be considered non-cellular communication and/or be associated to a non-cellular wireless communication network). Radio node 10 may generally be adapted to carry out any of the methods of operating a radio node like terminal or UE disclosed herein; in particular, it may comprise corresponding circuitry, e.g., processing circuitry, and/or modules, e.g., software modules. It may be considered that the radio node 10 comprises, and/or is connected or connectable, to a power supply.

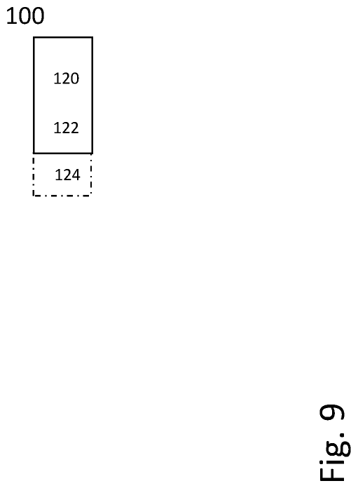

FIG. 9 schematically shows a radio node 100, which may in particular be implemented as a network node 100, for example an eNB or gNB or similar for NR. Radio node 100 comprises processing circuitry (which may also be referred to as control circuitry) 120, which may comprise a controller connected to a memory. Any module, e.g., transmitting module and/or receiving module and/or configuring module of the node 100 may be implemented in and/or executable by the processing circuitry 120. The processing circuitry 120 is connected to control radio circuitry 122 of the node 100, which provides receiver and transmitter and/or transceiver functionality (e.g., comprising one or more transmitters and/or receivers and/or transceivers). An antenna circuitry 124 may be connected or connectable to radio circuitry 122 for signal reception or transmittance and/or amplification. Node 100 may be adapted to carry out any of the methods for operating a radio node or network node disclosed herein; in particular, it may comprise corresponding circuitry, e.g., processing circuitry, and/or modules. The antenna circuitry 124 may be connected to and/or comprise an antenna array. The node 100, respectively its circuitry, may be adapted to perform any of the methods of operating a network node or a radio node as described herein; in particular, it may comprise corresponding circuitry, e.g., processing circuitry, and/or modules. The radio node 100 may generally comprise communication circuitry, e.g., for communication with another network node, like a radio node, and/or with a core network and/or an internet or local net, in particular with an information system, which may provide information and/or data to be transmitted to a user equipment.

In general, a block symbol and/or an allocation unit may represent and/or correspond to an extension in time domain, e.g., a time interval. A block symbol duration (the length of the time interval) may correspond to the duration of an OFDM symbol or a corresponding duration, and/or may be based and/or defined by a subcarrier spacing used (e.g., based on the numerology) or equivalent, and/or may correspond to the duration of a modulation symbol (e.g., for OFDM or similar frequency domain multiplexed types of signalling). It may be considered that a block symbol comprises a plurality of modulation symbols, e.g., based on a subcarrier spacing and/or numerology or equivalent, in particular for time domain multiplexed types (on the symbol level for a single transmitter) of signalling like single-carrier based signalling, e.g., SC-FDE or SC-FDMA (in particular, FDF-SC-FDMA or pulse-shaped SC-FDMA). The number of symbols may be based on and/or defined by the number of subcarrier to be DFTS-spread (for SC-FDMA) and/or be based on a number of FFT samples, e.g., for spreading and/or mapping, and/or equivalent, and/or may be predefined and/or configured or configurable. A block symbol in this context may comprise and/or contain a plurality of individual modulation symbols, which may be for example 1000 or more, or 3000 or more, or 3300 or more. The number of modulation symbols in a block symbol may be based and/or be dependent on a bandwidth scheduled for transmission of signalling in the block symbol. A block symbol and/or a number of block symbols (an integer smaller than 20, e.g., equal to or smaller than 14 or 7 or 4 or 2 or a flexible number) may be a unit (e.g., allocation unit) used or usable or intended e.g., for scheduling and/or allocation of resources, in particular in time domain. To a block symbol (e.g., scheduled or allocated) and/or block symbol group and/or allocation unit, there may be associated a frequency range and/or frequency domain allocation and/or bandwidth allocated for transmission.

An allocation unit, and/or a block symbol, may be associated to a specific (e.g., physical) channel and/or specific type of signalling, for example reference signalling. In some cases, there may be a block symbol associated to a channel that also is associated to a form of reference signalling and/or pilot signalling and/or tracking signalling associated to the channel, for example for timing purposes and/or decoding purposes (such signalling may comprise a low number of modulation symbols and/or resource elements of a block symbol, e.g., less than 10% or less than 5% or less than 1% of the modulation symbols and/or resource elements in a block symbol). To a block symbol, there may be associated resource elements; a resource element may be represented in time/frequency domain, e.g., by the smallest frequency unit carrying or mapped to (e.g., a subcarrier) in frequency domain and the duration of a modulation symbol in time domain. A block symbol may comprise, and/or to a block symbol may be associated, a structure allowing and/or comprising a number of modulation symbols, and/or association to one or more channels (and/or the structure may dependent on the channel the block symbol is associated to and/or is allocated or used for), and/or reference signalling (e.g., as discussed above), and/or one or more guard periods and/or transient periods, and/or one or more affixes (e.g., a prefix and/or suffix and/or one or more infixes (entered inside the block symbol)), in particular a cyclic prefix and/or suffix and/or infix. A cyclic affix may represent a repetition of signalling and/or modulation symbol/s used in the block symbol, with possible slight amendments to the signalling structure of the affix to provide a smooth and/or continuous and/or differentiable connection between affix signalling and signalling of modulation symbols associated to the content of the block symbol (e.g., channel and/or reference signalling structure). In some cases, in particular some OFDM-based waveforms, an affix may be included into a modulation symbol. In other cases, e.g., some single carrier-based waveforms, an affix may be represented by a sequence of modulation symbols within the block symbol. It may be considered that in some cases a block symbol is defined and/or used in the context of the associated structure.

In some variants, a reference beam and/or reference beams and/or reference signalling may correspond to and/or carry random access signalling, e.g., a random access preamble. Such a reference beam or signalling may be transmitted by another radio node. The signalling may indicate which beam is used for transmitting. Alternatively, the reference beams may be beams receiving the random access signalling. Random access signalling may be used for initial connection to the radio node and/or a cell provided by the radio node, and/or for reconnection. Utilising random access signalling facilitates quick and early beam selection. The random access signalling may be on a random access channel, e.g., based on broadcast information provided by the radio node (the radio node performing the beam selection), e.g., with synchronisation signalling (e.g., SSB block and/or associated thereto). The reference signalling may correspond to synchronisation signalling, e.g., transmitted by the radio node in a plurality of beams. The characteristics may be reported on by a node receiving the synchronisation signalling, e.g., in a random access process, e.g., a msg3 for contention resolution, which may be transmitted on a physical uplink shared channel based on a resource allocation provided by the radio node.

Data signalling may be on a data channel, for example on a PDSCH or PSSCH, or on a dedicated data channel, e.g., for low latency and/or high reliability, e.g., a URLLC channel. Control signalling may be on a control channel, for example on a common control channel or a PDCCH or PSCCH, and/or comprise one or more DCI messages or SCI messages. Reference signalling may be associated to control signalling and/or data signalling, e.g., DM-RS and/or PT-RS.

Reference signalling, for example, may comprise DM-RS and/or pilot signalling and/or discovery signalling and/or synchronisation signalling and/or sounding signalling and/or phase tracking reference signalling and/or cell-specific reference signalling and/or user-specific signalling, in particular CSI-RS. Reference signalling or signalling in general may be signalling with one or more signalling characteristics, in particular transmission power and/or sequence of modulation symbols and/or resource distribution and/or phase distribution known to the receiver. Thus, the receiver can use the reference signalling as a reference and/or for training and/or for compensation. The receiver can be informed about the reference signalling by the transmitter, e.g., being configured and/or signalling with control signalling, in particular physical layer signalling and/or higher layer signalling (e.g., DCI and/or RRC signalling), and/or may determine the corresponding information itself, e.g., a network node configuring a UE to transmit reference signalling. Reference signalling may be signalling comprising one or more reference symbols and/or structures. Reference signalling may be adapted for gauging and/or estimating and/or representing transmission conditions, e.g., channel conditions and/or transmission path conditions and/or channel (or signal or transmission) quality. It may be considered that the transmission characteristics (e.g., signal strength and/or form and/or modulation and/or timing) of reference signalling are available for both transmitter and receiver of the signalling (e.g., due to being predefined and/or configured or configurable and/or being communicated). Different types of reference signalling may be considered, e.g., pertaining to uplink, downlink or sidelink, cell-specific (in particular, cell-wide, e.g., CRS) or device or user specific (addressed to a specific target or user equipment, e.g., CSI-RS), demodulation-related (e.g., DMRS) and/or signal strength related, e.g., power-related or energy-related or amplitude-related (e.g., SRS or pilot signalling) and/or phase-related, etc.

References to specific resource structures like an allocation unit and/or block symbol and/or block symbol group and/or transmission timing structure and/or symbol and/or slot and/or mini-slot and/or subcarrier and/or carrier may pertain to a specific numerology, which may be predefined and/or configured or configurable. A transmission timing structure may represent a time interval, which may cover one or more symbols. Some examples of a transmission timing structure are transmission time interval (TTI), subframe, slot and mini-slot. A slot may comprise a predetermined, e.g., predefined and/or configured or configurable, number of symbols, e.g., 6 or 7, or 12 or 14. A mini-slot may comprise a number of symbols (which may in particular be configurable or configured) smaller than the number of symbols of a slot, in particular 1, 2, 3 or 4, or more symbols, e.g., less symbols than symbols in a slot. A transmission timing structure may cover a time interval of a specific length, which may be dependent on symbol time length and/or cyclic prefix used. A transmission timing structure may pertain to, and/or cover, a specific time interval in a time stream, e.g., synchronized for communication. Timing structures used and/or scheduled for transmission, e.g., slot and/or mini-slots, may be scheduled in relation to, and/or synchronized to, a timing structure provided and/or defined by other transmission timing structures. Such transmission timing structures may define a timing grid, e.g., with symbol time intervals within individual structures representing the smallest timing units. Such a timing grid may for example be defined by slots or subframes (wherein in some cases, subframes may be considered specific variants of slots). A transmission timing structure may have a duration (length in time) determined based on the durations of its symbols, possibly in addition to cyclic prefix/es used. The symbols of a transmission timing structure may have the same duration, or may in some variants have different duration. The number of symbols in a transmission timing structure may be predefined and/or configured or configurable, and/or be dependent on numerology. The timing of a mini-slot may generally be configured or configurable, in particular by the network and/or a network node. The timing may be configurable to start and/or end at any symbol of the transmission timing structure, in particular one or more slots.

There is generally considered a program product comprising instructions adapted for causing processing and/or control circuitry to carry out and/or control any method described herein, in particular when executed on the processing and/or control circuitry. Also, there is considered a carrier medium arrangement carrying and/or storing a program product as described herein.

A carrier medium arrangement may comprise one or more carrier media. Generally, a carrier medium may be accessible and/or readable and/or receivable by processing or control circuitry. Storing data and/or a program product and/or code may be seen as part of carrying data and/or a program product and/or code. A carrier medium generally may comprise a guiding/transporting medium and/or a storage medium. A guiding/transporting medium may be adapted to carry and/or carry and/or store signals, in particular electromagnetic signals and/or electrical signals and/or magnetic signals and/or optical signals. A carrier medium, in particular a guiding/transporting medium, may be adapted to guide such signals to carry them. A carrier medium, in particular a guiding/transporting medium, may comprise the electromagnetic field, e.g., radio waves or microwaves, and/or optically transmissive material, e.g., glass fiber, and/or cable. A storage medium may comprise at least one of a memory, which may be volatile or non-volatile, a buffer, a cache, an optical disc, magnetic memory, flash memory, etc.

A system comprising one or more radio nodes as described herein, in particular a network node and a user equipment, is described. The system may be a wireless communication system, and/or provide and/or represent a radio access network.

Moreover, there may be generally considered a method of operating an information system, the method comprising providing information. Alternatively, or additionally, an information system adapted for providing information may be considered. Providing information may comprise providing information for, and/or to, a target system, which may comprise and/or be implemented as radio access network and/or a radio node, in particular a network node or user equipment or terminal. Providing information may comprise transferring and/or streaming and/or sending and/or passing on the information, and/or offering the information for such and/or for download, and/or triggering such providing, e.g., by triggering a different system or node to stream and/or transfer and/or send and/or pass on the information. The information system may comprise, and/or be connected or connectable to, a target, for example via one or more intermediate systems, e.g., a core network and/or internet and/or private or local network. Information may be provided utilising and/or via such intermediate system/s. Providing information may be for radio transmission and/or for transmission via an air interface and/or utilising a RAN or radio node as described herein. Connecting the information system to a target, and/or providing information, may be based on a target indication, and/or adaptive to a target indication. A target indication may indicate the target, and/or one or more parameters of transmission pertaining to the target and/or the paths or connections over which the information is provided to the target. Such parameter/s may in particular pertain to the air interface and/or radio access network and/or radio node and/or network node. Example parameters may indicate for example type and/or nature of the target, and/or transmission capacity (e.g., data rate) and/or latency and/or reliability and/or cost, respectively one or more estimates thereof. The target indication may be provided by the target, or determined by the information system, e.g., based on information received from the target and/or historical information, and/or be provided by a user, for example a user operating the target or a device in communication with the target, e.g., via the RAN and/or air interface. For example, a user may indicate on a user equipment communicating with the information system that information is to be provided via a RAN, e.g., by selecting from a selection provided by the information system, for example on a user application or user interface, which may be a web interface. An information system may comprise one or more information nodes. An information node may generally comprise processing circuitry and/or communication circuitry. In particular, an information system and/or an information node may be implemented as a computer and/or a computer arrangement, e.g., a host computer or host computer arrangement and/or server or server arrangement. In some variants, an interaction server (e.g., web server) of the information system may provide a user interface, and based on user input may trigger transmitting and/or streaming information provision to the user (and/or the target) from another server, which may be connected or connectable to the interaction server and/or be part of the information system or be connected or connectable thereto. The information may be any kind of data, in particular data intended for a user of for use at a terminal, e.g., video data and/or audio data and/or location data and/or interactive data and/or game-related data and/or environmental data and/or technical data and/or traffic data and/or vehicular data and/or circumstantial data and/or operational data. The information provided by the information system may be mapped to, and/or mappable to, and/or be intended for mapping to, communication or data signalling and/or one or more data channels as described herein (which may be signalling or channel/s of an air interface and/or used within a RAN and/or for radio transmission). It may be considered that the information is formatted based on the target indication and/or target, e.g., regarding data amount and/or data rate and/or data structure and/or timing, which in particular may be pertaining to a mapping to communication or data signalling and/or a data channel. Mapping information to data signalling and/or data channel/s may be considered to refer to using the signalling/channel/s to carry the data, e.g., on higher layers of communication, with the signalling/channel/s underlying the transmission. A target indication generally may comprise different components, which may have different sources, and/or which may indicate different characteristics of the target and/or communication path/s thereto. A format of information may be specifically selected, e.g., from a set of different formats, for information to be transmitted on an air interface and/or by a RAN as described herein. This may be particularly pertinent since an air interface may be limited in terms of capacity and/or of predictability, and/or potentially be cost sensitive. The format may be selected to be adapted to the transmission indication, which may in particular indicate that a RAN or radio node as described herein is in the path (which may be the indicated and/or planned and/or expected path) of information between the target and the information system. A (communication) path of information may represent the interface/s (e.g., air and/or cable interfaces) and/or the intermediate system/s (if any), between the information system and/or the node providing or transferring the information, and the target, over which the information is, or is to be, passed on. A path may be (at least partly) undetermined when a target indication is provided, and/or the information is provided/transferred by the information system, e.g., if an internet is involved, which may comprise multiple, dynamically chosen paths. Information and/or a format used for information may be packet-based, and/or be mapped, and/or be mappable and/or be intended for mapping, to packets. Alternatively, or additionally, there may be considered a method for operating a target device comprising providing a target indicating to an information system. More alternatively, or additionally, a target device may be considered, the target device being adapted for providing a target indication to an information system. In another approach, there may be considered a target indication tool adapted for, and/or comprising an indication module for, providing a target indication to an information system. The target device may generally be a target as described above. A target indication tool may comprise, and/or be implemented as, software and/or application or app, and/or web interface or user interface, and/or may comprise one or more modules for implementing actions performed and/or controlled by the tool. The tool and/or target device may be adapted for, and/or the method may comprise, receiving a user input, based on which a target indicating may be determined and/or provided. Alternatively, or additionally, the tool and/or target device may be adapted for, and/or the method may comprise, receiving information and/or communication signalling carrying information, and/or operating on, and/or presenting (e.g., on a screen and/or as audio or as other form of indication), information. The information may be based on received information and/or communication signalling carrying information. Presenting information may comprise processing received information, e.g., decoding and/or transforming, in particular between different formats, and/or for hardware used for presenting. Operating on information may be independent of or without presenting, and/or proceed or succeed presenting, and/or may be without user interaction or even user reception, for example for automatic processes, or target devices without (e.g., regular) user interaction like MTC devices, of for automotive or transport or industrial use. The information or communication signalling may be expected and/or received based on the target indication. Presenting and/or operating on information may generally comprise one or more processing steps, in particular decoding and/or executing and/or interpreting and/or transforming information. Operating on information may generally comprise relaying and/or transmitting the information, e.g., on an air interface, which may include mapping the information onto signalling (such mapping may generally pertain to one or more layers, e.g., one or more layers of an air interface, e.g., RLC (Radio Link Control) layer and/or MAC layer and/or physical layer/s). The information may be imprinted (or mapped) on communication signalling based on the target indication, which may make it particularly suitable for use in a RAN (e.g., for a target device like a network node or in particular a UE or terminal). The tool may generally be adapted for use on a target device, like a UE or terminal. Generally, the tool may provide multiple functionalities, e.g., for providing and/or selecting the target indication, and/or presenting, e.g., video and/or audio, and/or operating on and/or storing received information. Providing a target indication may comprise transmitting or transferring the indication as signalling, and/or carried on signalling, in a RAN, for example if the target device is a UE, or the tool for a UE. It should be noted that such provided information may be transferred to the information system via one or more additionally communication interfaces and/or paths and/or connections. The target indication may be a higher-layer indication and/or the information provided by the information system may be higher-layer information, e.g., application layer or user-layer, in particular above radio layers like transport layer and physical layer. The target indication may be mapped on physical layer radio signalling, e.g., related to or on the user-plane, and/or the information may be mapped on physical layer radio communication signalling, e.g., related to or on the user-plane (in particular, in reverse communication directions). The described approaches allow a target indication to be provided, facilitating information to be provided in a specific format particularly suitable and/or adapted to efficiently use an air interface. A user input may for example represent a selection from a plurality of possible transmission modes or formats, and/or paths, e.g., in terms of data rate and/or packaging and/or size of information to be provided by the information system.

In general, a numerology and/or subcarrier spacing may indicate the bandwidth (in frequency domain) of a subcarrier of a carrier, and/or the number of subcarriers in a carrier and/or the numbering of the subcarriers in a carrier, and/or the symbol time length. Different numerologies may in particular be different in the bandwidth of a subcarrier. In some variants, all the subcarriers in a carrier have the same bandwidth associated to them. The numerology and/or subcarrier spacing may be different between carriers in particular regarding the subcarrier bandwidth. A symbol time length, and/or a time length of a timing structure pertaining to a carrier may be dependent on the carrier frequency, and/or the subcarrier spacing and/or the numerology. In particular, different numerologies may have different symbol time lengths, even on the same carrier.

Signalling may generally comprise one or more (e.g., modulation) symbols and/or signals and/or messages. A signal may comprise or represent one or more bits. An indication may represent signalling, and/or be implemented as a signal, or as a plurality of signals. One or more signals may be included in and/or represented by a message. Signalling, in particular control signalling, may comprise a plurality of signals and/or messages, which may be transmitted on different carriers and/or be associated to different signalling processes, e.g., representing and/or pertaining to one or more such processes and/or corresponding information. An indication may comprise signalling, and/or a plurality of signals and/or messages and/or may be comprised therein, which may be transmitted on different carriers and/or be associated to different acknowledgement signalling processes, e.g., representing and/or pertaining to one or more such processes. Signalling associated to a channel may be transmitted such that represents signalling and/or information for that channel, and/or that the signalling is interpreted by the transmitter and/or receiver to belong to that channel. Such signalling may generally comply with transmission parameters and/or format/s for the channel.

An antenna arrangement may comprise one or more antenna elements (radiating elements), which may be combined in antenna arrays. An antenna array or subarray may comprise one antenna element, or a plurality of antenna elements, which may be arranged e.g., two dimensionally (for example, a panel) or three dimensionally. It may be considered that each antenna array or subarray or element is separately controllable, respectively that different antenna arrays are controllable separately from each other. A single antenna element/radiator may be considered the smallest example of a subarray. Examples of antenna arrays comprise one or more multi-antenna panels or one or more individually controllable antenna elements. An antenna arrangement may comprise a plurality of antenna arrays. It may be considered that an antenna arrangement is associated to a (specific and/or single) radio node, e.g., a configuring or informing or scheduling radio node, e.g., to be controlled or controllable by the radio node. An antenna arrangement associated to a UE or terminal may be smaller (e.g., in size and/or number of antenna elements or arrays) than the antenna arrangement associated to a network node. Antenna elements of an antenna arrangement may be configurable for different arrays, e.g., to change the beamforming characteristics. In particular, antenna arrays may be formed by combining one or more independently or separately controllable antenna elements or subarrays. The beams may be provided by analog beamforming, or in some variants by digital beamforming, or by hybrid beamforming combing analog and digital beamforming. The informing radio nodes may be configured with the manner of beam transmission, e.g., by transmitting a corresponding indicator or indication, for example as beam identify indication. However, there may be considered cases in which the informing radio node/s are not configured with such information, and/or operate transparently, not knowing the way of beamforming used. An antenna arrangement may be considered separately controllable in regard to the phase and/or amplitude/power and/or gain of a signal feed to it for transmission, and/or separately controllable antenna arrangements may comprise an independent or separate transmit and/or receive unit and/or ADC (Analog-Digital-Converter, alternatively an ADC chain) or DCA (Digital-to-Analog Converter, alternatively a DCA chain) to convert digital control information into an analog antenna feed for the whole antenna arrangement (the ADC/DCA may be considered part of, and/or connected or connectable to, antenna circuitry) or vice versa. A scenario in which an ADC or DCA is controlled directly for beamforming may be considered an analog beamforming scenario; such controlling may be performed after encoding/decoding and/or after modulation symbols have been mapped to resource elements. This may be on the level of antenna arrangements using the same ADC/DCA, e.g., one antenna element or a group of antenna elements associated to the same ADC/DCA. Digital beamforming may correspond to a scenario in which processing for beamforming is provided before feeding signalling to the ADC/DCA, e.g., by using one or more precoder/s and/or by precoding information, for example before and/or when mapping modulation symbols to resource elements. Such a precoder for beamforming may provide weights, e.g., for amplitude and/or phase, and/or may be based on a (precoder) codebook, e.g., selected from a codebook. A precoder may pertain to one beam or more beams, e.g., defining the beam or beams. The codebook may be configured or configurable, and/or be predefined. DFT beamforming may be considered a form of digital beamforming, wherein a DFT procedure is used to form one or more beams. Hybrid forms of beamforming may be considered.

A beam may be defined by a spatial and/or angular and/or spatial angular distribution of radiation and/or a spatial angle (also referred to as solid angle) or spatial (solid) angle distribution into which radiation is transmitted (for transmission beamforming) or from which it is received (for reception beamforming). Reception beamforming may comprise only accepting signals coming in from a reception beam (e.g., using analog beamforming to not receive outside reception beam/s), and/or sorting out signals that do not come in in a reception beam, e.g., in digital postprocessing, e.g., digital beamforming. A beam may have a solid angle equal to or smaller than 4*pi sr (4*pi correspond to a beam covering all directions), in particular smaller than 2*pi, or pi, or pi/2, or pi/4 or pi/8 or pi/16. In particular for high frequencies, smaller beams may be used. Different beams may have different directions and/or sizes (e.g., solid angle and/or reach). A beam may have a main direction, which may be defined by a main lobe (e.g., center of the main lobe, e.g., pertaining to signal strength and/or solid angle, which may be averaged and/or weighted to determine the direction), and may have one or more sidelobes. A lobe may generally be defined to have a continuous or contiguous distribution of energy and/or power transmitted and/or received, e.g., bounded by one or more contiguous or contiguous regions of zero energy (or practically zero energy). A main lobe may comprise the lobe with the largest signal strength and/or energy and/or power content. However, sidelobes usually appear due to limitations of beamforming, some of which may carry signals with significant strength, and may cause multi-path effects. A sidelobe may generally have a different direction than a main lobe and/or other side lobes, however, due to reflections a sidelobe still may contribute to transmitted and/or received energy or power. A beam may be swept and/or switched over time, e.g., such that its (main) direction is changed, but its shape (angular/solid angle distribution) around the main direction is not changed, e.g., from the transmitter's views for a transmission beam, or the receiver's view for a reception beam, respectively. Sweeping may correspond to continuous or near continuous change of main direction (e.g., such that after each change, the main lobe from before the change covers at least partly the main lobe after the change, e.g., at least to 50 or 75 or 90 percent). Switching may correspond to switching direction non-continuously, e.g., such that after each change, the main lobe from before the change does not cover the main lobe after the change, e.g., at most to 50 or 25 or 10 percent.

In some cases, to one or more beams or signals or signallings may be associated a Quasi-CoLocation (QCL) characteristic or set of characteristics, or QCL class (also referred to as QCL type) or QCL identity; beams or signal or signallings sharing such may be considered to be Quasi-Colocated. Quasi-Colocated beams or signals or signallings may be considered (e.g., by a receiver) as the same beam or originating from the same transmitter or transmission source, at least in regard to the QCL characteristic or set or class or identity, and/or to share the characteristic/s. QCL characteristics may pertain to propagation of signalling, and/or one or more delay characteristics, and/or pathloss, and/or signal quality, and/or signal strength, and/or beam direction, and/or beam shape (in particular, angle or area, e.g., area of coverage), and/or Doppler shift, and/or Doppler spread, and/or delay spread, and/or time synchronisation, and/or frequency synchronisation, and/or one or more other parameters, e.g., pertaining to a propagation channel and/or spatial RX parameter/s (which may refer to reception beam and/or transmission beam, e.g., shape or coverage or direction). A QCL characteristic may pertain to a specific channel (e.g., physical layer channel like a control channel or data channel) and/or reference signalling type and/or antenna port. Different QCL classes or types may pertain to different QCL characteristics or sets of characteristics; a QCL class may define and/or pertain to one or more criteria and/or thresholds and/or ranges for one or more QCL characteristics beams have to fulfill to be considered Quasi-Colocated according to this class; a QCL identity may refer to and/or represent all beams being quasi-colocated, according to a QCL class. Different classes may pertain to one or more of the same characteristics (e.g., different classes may have different criteria and/or thresholds and/or ranges for one or more characteristics) and/or to different characteristics. A QCL indication may be seen as a form of beam indication, e.g., pertaining to all beams belonging to one QCL class and/or QCL identity and/or quasi-colocated beams. A QCL identity may be indicated by a QCL indication. In some cases, a beam, and/or a beam indication, may be considered to refer and/or represent a to a QCL identity, and/or to represent quasi-colocated beams or signals or signallings. To a QCL identity, there may be associated one or more ports, e.g., for one or more reference signalling types, e.g., DM-RS and/or CSI-RS and/or PT-RS. A QCI class or identity may be indicated by, and/or represented by, and/or be associated to a Transmission Configuration Indicator (TCI), which may be indicated with control signalling, e.g., in a DCI.

Transmission on multiple layers (multi-layer transmission) may refer to transmission of communication signalling and/or reference signalling simultaneously in one or more beams and/or using a plurality of transmission sources, e.g., controlled by one network node or one wireless device. The layers may refer to layers of transmission; a layer may be considered to represent one data or signalling stream. Different layers may carry different data and/or data streams, e.g., to increase data throughput. In some cases, the same data or data stream may be transported on different layers, e.g., to increase reliability. Multi-layer transmission may provide diversity, e.g., transmission diversity and/or spatial diversity. It may be considered that multi-layer transmission comprises 2, or more than 2 layers; the number of layers of transmission may be represented by a rank or rank indication.

Signal strength may be a representation of signal power and/or signal energy, e.g., as seen from a transmitting node or a receiving node. A beam with larger strength at transmission (e.g., according to the beamforming used) than another beam does may not necessarily have larger strength at the receiver, and vice versa, for example due to interference and/or obstruction and/or dispersion and/or absorption and/or reflection and/or attrition or other effects influencing a beam or the signalling it carries. Signal quality may in general be a representation of how well a signal may be received over noise and/or interference. A beam with better signal quality than another beam does not necessarily have a larger beam strength than the other beam. Signal quality may be represented for example by SIR, SNR, SINR, BER, BLER, Energy per resource element over noise/interference or another corresponding quality measure. Signal quality and/or signal strength may pertain to, and/or may be measured with respect to, a beam, and/or specific signalling carried by the beam, e.g., reference signalling and/or a specific channel, e.g., a data channel or control channel. Signal strength may be represented by received signal strength (e.g., as RSRP), and/or relative signal strength, e.g., in comparison to a reference signal (strength), or Energy per resource element or a transmitter power.

Uplink or sidelink signalling may be OFDMA (Orthogonal Frequency Division Multiple Access) or SC-FDMA (Single Carrier Frequency Division Multiple Access) signalling. Downlink signalling may in particular be OFDMA signalling. However, signalling is not limited thereto (Filter-Bank based signalling and/or Single-Carrier based signalling, e.g., SC-FDE signalling, may be considered alternatives).

A radio node may generally be considered a device or node adapted for wireless and/or radio (and/or millimeter wave) frequency communication, and/or for communication utilising an air interface, e.g., according to a communication standard.

A radio node may be a network node, or a user equipment or terminal. A network node may be any radio node of a wireless communication network, e.g., a base station and/or gNodeB (gNB) and/or eNodeB (eNB) and/or relay node and/or micro/nano/pico/femto node and/or transmission point (TP) and/or access point (AP) and/or other node, in particular for a RAN or other wireless communication network as described herein.

The terms user equipment (UE) and terminal may be considered to be interchangeable in the context of this disclosure. A wireless device, user equipment or terminal may represent an end device for communication utilising the wireless communication network, and/or be implemented as a user equipment according to a standard. Examples of user equipments may comprise a phone like a smartphone, a personal communication device, a mobile phone or terminal, a computer, in particular laptop, a sensor or machine with radio capability (and/or adapted for the air interface), in particular for MTC (Machine-Type-Communication, sometimes also referred to M2M, Machine-To-Machine), or a vehicle adapted for wireless communication. A user equipment or terminal may be mobile or stationary. A wireless device generally may comprise, and/or be implemented as, processing circuitry and/or radio circuitry, which may comprise one or more chips or sets of chips. The circuitry and/or circuitries may be packaged, e.g., in a chip housing, and/or may have one or more physical interfaces to interact with other circuitry and/or for power supply. Such a wireless device may be intended for use in a user equipment or terminal.

A radio node may generally comprise processing circuitry and/or radio circuitry. A radio node, in particular a network node, may in some cases comprise cable circuitry and/or communication circuitry, with which it may be connected or connectable to another radio node and/or a core network.

Circuitry may comprise integrated circuitry. Processing circuitry may comprise one or more processors and/or controllers (e.g., microcontrollers), and/or ASICs (Application Specific Integrated Circuitry) and/or FPGAs (Field Programmable Gate Array), or similar. It may be considered that processing circuitry comprises, and/or is (operatively) connected or connectable to one or more memories or memory arrangements. A memory arrangement may comprise one or more memories. A memory may be adapted to store digital information. Examples for memories comprise volatile and non-volatile memory, and/or Random Access Memory (RAM), and/or Read-Only-Memory (ROM), and/or magnetic and/or optical memory, and/or flash memory, and/or hard disk memory, and/or EPROM or EEPROM (Erasable Programmable ROM or Electrically Erasable Programmable ROM).

Radio circuitry may comprise one or more transmitters and/or receivers and/or transceivers (a transceiver may operate or be operable as transmitter and receiver, and/or may comprise joint or separated circuitry for receiving and transmitting, e.g., in one package or housing), and/or may comprise one or more amplifiers and/or oscillators and/or filters, and/or may comprise, and/or be connected or connectable to antenna circuitry and/or one or more antennas and/or antenna arrays. An antenna array may comprise one or more antennas, which may be arranged in a dimensional array, e.g., 2D or 3D array, and/or antenna panels. A remote radio head (RRH) may be considered as an example of an antenna array. However, in some variants, an RRH may be also be implemented as a network node, depending on the kind of circuitry and/or functionality implemented therein.

Communication circuitry may comprise radio circuitry and/or cable circuitry. Communication circuitry generally may comprise one or more interfaces, which may be air interface/s and/or cable interface/s and/or optical interface/s, e.g., laser-based. Interface/s may be in particular packet-based. Cable circuitry and/or a cable interfaces may comprise, and/or be connected or connectable to, one or more cables (e.g., optical fiber-based and/or wire-based), which may be directly or indirectly (e.g., via one or more intermediate systems and/or interfaces) be connected or connectable to a target, e.g., controlled by communication circuitry and/or processing circuitry.

Any one or any combination or all of modules disclosed herein may be implemented in software and/or firmware and/or hardware. Different modules may be associated to different components of a radio node, e.g., different circuitries, or different parts of a circuitry. It may be considered that a module is distributed over different components and/or circuitries. A program product as described herein may comprise the modules related to a device on which the program product is intended (e.g., a user equipment or network node) to be executed (the execution may be performed on, and/or controlled by the associated circuitry).

A wireless communication network may be or comprise a radio access network and/or a backhaul network (e.g., a relay or backhaul network or an IAB network), and/or a Radio Access Network (RAN) in particular according to a communication standard. A communication standard may in particular a standard according to 3GPP and/or 5G, e.g., according to NR or LTE, in particular LTE Evolution.

A wireless communication network may be and/or comprise a Radio Access Network (RAN), which may be and/or comprise any kind of cellular and/or wireless radio network, which may be connected or connectable to a core network. The approaches described herein are particularly suitable for a 5G network, e.g., LTE Evolution and/or NR (New Radio), respectively successors thereof. A RAN may comprise one or more network nodes, and/or one or more terminals, and/or one or more radio nodes. A network node may in particular be a radio node adapted for radio and/or wireless and/or cellular communication with one or more terminals. A terminal may be any device adapted for radio and/or wireless and/or cellular communication with or within a RAN, e.g., a user equipment (UE) or mobile phone or smartphone or computing device or vehicular communication device or device for machine-type-communication (MTC), etc. A terminal may be mobile, or in some cases stationary. A RAN or a wireless communication network may comprise at least one network node and a UE, or at least two radio nodes. There may be generally considered a wireless communication network or system, e.g., a RAN or RAN system, comprising at least one radio node, and/or at least one network node and at least one terminal.

Transmitting in downlink may pertain to transmission from the network or network node to the terminal. Transmitting in uplink may pertain to transmission from the terminal to the network or network node. Transmitting in sidelink may pertain to (direct) transmission from one terminal to another. Uplink, downlink and sidelink (e.g., sidelink transmission and reception) may be considered communication directions. In some variants, uplink and downlink may also be used to described wireless communication between network nodes, e.g., for wireless backhaul and/or relay communication and/or (wireless) network communication for example between base stations or similar network nodes, in particular communication terminating at such. It may be considered that backhaul and/or relay communication and/or network communication is implemented as a form of sidelink or uplink communication or similar thereto.

Control information or a control information message or corresponding signalling (control signalling) may be transmitted on a control channel, e.g., a physical control channel, which may be a downlink channel or (or a sidelink channel in some cases, e.g., one UE scheduling another UE). For example, control information/allocation information may be signaled by a network node on PDCCH (Physical Downlink Control Channel) and/or a PDSCH (Physical Downlink Shared Channel) and/or a HARQ-specific channel. Acknowledgement signalling, e.g., as a form of control information or signalling like uplink control information/signalling, may be transmitted by a terminal on a PUCCH (Physical Uplink Control Channel) and/or PUSCH (Physical Uplink Shared Channel) and/or a HARQ-specific channel. Multiple channels may apply for multi-component/multi-carrier indication or signalling.

Scheduling may comprise indicating, e.g., with control signalling like DCI or SCI signalling and/or signalling on a control channel like PDCCH or PSCCH, one or more scheduling opportunities of a configuration intended to carry data signalling or subject signalling. The configuration may be represented or representable by, and/or correspond to, a table. A scheduling assignment may for example point to an opportunity of the reception allocation configuration, e.g., indexing a table of scheduling opportunities. In some cases, a reception allocation configuration may comprise 15 or 16 scheduling opportunities. The configuration may in particular represent allocation in time. It may be considered that the reception allocation configuration pertains to data signalling, in particular on a physical data channel like PDSCH or PSSCH. In general, the reception allocation configuration may pertain to downlink signalling, or in some scenarios to sidelink signalling. Control signalling scheduling subject transmission like data signalling may point and/or index and/or refer to and/or indicate a scheduling opportunity of the reception allocation configuration. It may be considered that the reception allocation configuration is configured or configurable with higher-layer signalling, e.g., RRC or MAC layer signalling. The reception allocation configuration may be applied and/or applicable and/or valid for a plurality of transmission timing intervals, e.g., such that for each interval, one or more opportunities may be indicated or allocated for data signalling. These approaches allow efficient and flexible scheduling, which may be semi-static, but may updated or reconfigured on useful timescales in response to changes of operation conditions.

Signalling may generally be considered to represent an electromagnetic wave structure (e.g., over a time interval and frequency interval), which is intended to convey information to at least one specific or generic (e.g., anyone who might pick up the signalling) target. A process of signalling may comprise transmitting the signalling. Transmitting signalling, in particular control signalling or communication signalling, e.g., comprising, or representing acknowledgement signalling and/or resource requesting information, may comprise encoding and/or modulating. Encoding and/or modulating may comprise error detection coding and/or forward error correction encoding and/or scrambling. Receiving signalling like control signalling or data signalling may comprise corresponding decoding and/or demodulation, e.g., based on reference signalling associated to the signalling to be received. Error detection coding may comprise, and/or be based on, parity or checksum approaches, e.g., CRC (Cyclic Redundancy Check). Forward error correction coding may comprise and/or be based on for example turbo coding and/or Reed-Muller coding, and/or Polar coding and/or LDPC coding (Low Density Parity Check). The type of coding used may be based on the channel (e.g., physical channel) the coded signal is associated to. A code rate may represent the ratio of the number of information bits before encoding to the number of encoded bits after encoding, considering that encoding adds coding bits for error detection coding and forward error correction. Coded bits may refer to information bits (also called systematic bits) plus coding bits.

Transmitting acknowledgement signalling may in general be based on and/or in response to subject transmission, and/or to control signalling scheduling subject transmission. Such control signalling and/or subject signalling may be transmitted by a signalling radio node (which may be a network node, and/or a node associated to it, e.g., in a dual connectivity scenario. Subject transmission and/or subject signalling may be transmission or signalling to which ACK/NACK or acknowledgement information pertains, e.g., indicating correct or incorrect reception and/or decoding of the subject transmission or signalling. Subject signalling or transmission may in particular comprise and/or be represented by data signalling, e.g., on a PDSCH or PSSCH, or some forms of control signalling, e.g., on a PDCCH or PSSCH, for example for specific formats.

Scheduling may comprise indicating, e.g., with control signalling like DCI or SCI signalling and/or signalling on a control channel like PDCCH or PSCCH, one or more scheduling opportunities of a configuration intended to carry data signalling or subject signalling. The configuration may be represented or representable by, and/or correspond to, a table. A scheduling assignment may for example point to an opportunity of the reception allocation configuration, e.g., indexing a table of scheduling opportunities. In some cases, a reception allocation configuration may comprise 15 or 16 scheduling opportunities. The configuration may in particular represent allocation in time. It may be considered that the reception allocation configuration pertains to data signalling, in particular on a physical data channel like PDSCH or PSSCH. In general, the reception allocation configuration may pertain to downlink signalling, or in some scenarios to sidelink signalling. Control signalling scheduling subject transmission like data signalling may point and/or index and/or refer to and/or indicate a scheduling opportunity of the reception allocation configuration. It may be considered that the reception allocation configuration is configured or configurable with higher-layer signalling, e.g., RRC or MAC layer signalling. The reception allocation configuration may be applied and/or applicable and/or valid for a plurality of transmission timing intervals, e.g., such that for each interval, one or more opportunities may be indicated or allocated for data signalling. These approaches allow efficient and flexible scheduling, which may be semi-static, but may updated or reconfigured on useful timescales in response to changes of operation conditions.

Control information, e.g., in a control information message, in this context may in particular be implemented as and/or represented by a scheduling assignment, which may indicate subject transmission for feedback (transmission of acknowledgement signalling), and/or reporting timing and/or frequency resources and/or code resources. Reporting timing may indicate a timing for scheduled acknowledgement signalling, e.g., slot and/or symbol and/or resource set. Control information may be carried by control signalling.

Subject transmissions may comprise one or more individual transmissions. Scheduling assignments may comprise one or more scheduling assignments. It should generally be noted that in a distributed system, subject transmissions, configuration and/or scheduling may be provided by different nodes or devices or transmission points. Different subject transmissions may be on the same carrier or different carriers (e.g., in a carrier aggregation), and/or same or different bandwidth parts, and/or on the same or different layers or beams, e.g., in a MIMO scenario, and/or to same or different ports. Generally, subject transmissions may pertain to different HARQ or ARQ processes (or different sub-processes, e.g., in MIMO with different beams/layers associated to the same process identifier, but different sub-process-identifiers like swap bits). A scheduling assignment and/or a HARQ codebook may indicate a target HARQ structure. A target HARQ structure may for example indicate an intended HARQ response to a subject transmission, e.g., the number of bits and/or whether to provide code block group level response or not. However, it should be noted that the actual structure used may differ from the target structure, e.g., due to the total size of target structures for a subpattern being larger than the predetermined size.

Communication signalling may comprise, and/or represent, and/or be implemented as, data signalling, and/or user plane signalling. Communication signalling may be associated to a data channel, e.g., a physical downlink channel or physical uplink channel or physical sidelink channel, in particular a PDSCH (Physical Downlink Shared Channel) or PSSCH (Physical Sidelink Shared Channel). Generally, a data channel may be a shared channel or a dedicated channel. Data signalling may be signalling associated to and/or on a data channel.

An indication generally may explicitly and/or implicitly indicate the information it represents and/or indicates. Implicit indication may for example be based on position and/or resource used for transmission. Explicit indication may for example be based on a parametrisation with one or more parameters, and/or one or more index or indices, and/or one or more bit patterns representing the information. It may in particular be considered that control signalling as described herein, based on the utilised resource sequence, implicitly indicates the control signalling type.

A resource element may generally describe the smallest individually usable and/or encodable and/or decodable and/or modulatable and/or demodulatable time-frequency resource, and/or may describe a time-frequency resource covering a symbol time length in time and a subcarrier in frequency. A signal may be allocatable and/or allocated to a resource element. A subcarrier may be a subband of a carrier, e.g., as defined by a standard. A carrier may define a frequency and/or frequency band for transmission and/or reception. In some variants, a signal (jointly encoded/modulated) may cover more than one resource elements. A resource element may generally be as defined by a corresponding standard, e.g., NR or LTE. As symbol time length and/or subcarrier spacing (and/or numerology) may be different between different symbols and/or subcarriers, different resource elements may have different extension (length/width) in time and/or frequency domain, in particular resource elements pertaining to different carriers.

A resource generally may represent a time-frequency and/or code resource, on which signalling, e.g., according to a specific format, may be communicated, for example transmitted and/or received, and/or be intended for transmission and/or reception.

A border symbol (or allocation unit) may generally represent a starting symbol (allocation unit) or an ending symbol (allocation unit) for transmitting and/or receiving. A starting symbol (or allocation unit) may in particular be a starting symbol of uplink or sidelink signalling, for example control signalling or data signalling. Such signalling may be on a data channel or control channel, e.g., a physical channel, in particular a physical uplink shared channel (like PUSCH) or a sidelink data or shared channel, or a physical uplink control channel (like PUCCH) or a sidelink control channel. If the starting symbol (or allocation unit) is associated to control signalling (e.g., on a control channel), the control signalling may be in response to received signalling (in sidelink or downlink), e.g., representing acknowledgement signalling associated thereto, which may be HARQ or ARQ signalling. An ending symbol (or allocation unit) may represent an ending symbol (in time) of downlink or sidelink transmission or signalling, which may be intended or scheduled for the radio node or user equipment. Such downlink signalling may in particular be data signalling, e.g., on a physical downlink channel like a shared channel, e.g., a PDSCH (Physical Downlink Shared Channel). A starting symbol (or allocation unit) may be determined based on, and/or in relation to, such an ending symbol (or allocation unit).

Configuring a radio node, in particular a terminal or user equipment, may refer to the radio node being adapted or caused or set and/or instructed to operate according to the configuration. Configuring may be done by another device, e.g., a network node (for example, a radio node of the network like a base station or eNodeB) or network, in which case it may comprise transmitting configuration data to the radio node to be configured. Such configuration data may represent the configuration to be configured and/or comprise one or more instruction pertaining to a configuration, e.g., a configuration for transmitting and/or receiving on allocated resources, in particular frequency resources. A radio node may configure itself, e.g., based on configuration data received from a network or network node. A network node may utilise, and/or be adapted to utilise, its circuitry/ies for configuring. Allocation information may be considered a form of configuration data. Configuration data may comprise and/or be represented by configuration information, and/or one or more corresponding indications and/or message/s

Generally, configuring may include determining configuration data representing the configuration and providing, e.g., transmitting, it to one or more other nodes (parallel and/or sequentially), which may transmit it further to the radio node (or another node, which may be repeated until it reaches the wireless device). Alternatively, or additionally, configuring a radio node, e.g., by a network node or other device, may include receiving configuration data and/or data pertaining to configuration data, e.g., from another node like a network node, which may be a higher-level node of the network, and/or transmitting received configuration data to the radio node. Accordingly, determining a configuration and transmitting the configuration data to the radio node may be performed by different network nodes or entities, which may be able to communicate via a suitable interface, e.g., an X2 interface in the case of LTE or a corresponding interface for NR. Configuring a terminal may comprise scheduling downlink and/or uplink transmissions for the terminal, e.g., downlink data and/or downlink control signalling and/or DCI and/or uplink control or data or communication signalling, in particular acknowledgement signalling, and/or configuring resources and/or a resource pool therefor.

A resource structure may be considered to be neighbored in frequency domain by another resource structure, if they share a common border frequency, e.g., one as an upper frequency border and the other as a lower frequency border. Such a border may for example be represented by the upper end of a bandwidth assigned to a subcarrier n, which also represents the lower end of a bandwidth assigned to a subcarrier n+1. A resource structure may be considered to be neighbored in time domain by another resource structure, if they share a common border time, e.g., one as an upper (or right in the figures) border and the other as a lower (or left in the figures) border. Such a border may for example be represented by the end of the symbol time interval assigned to a symbol n, which also represents the beginning of a symbol time interval assigned to a symbol n+1.

Generally, a resource structure being neighbored by another resource structure in a domain may also be referred to as abutting and/or bordering the other resource structure in the domain.

A resource structure may in general represent a structure in time and/or frequency domain, in particular representing a time interval and a frequency interval. A resource structure may comprise and/or be comprised of resource elements, and/or the time interval of a resource structure may comprise and/or be comprised of symbol time interval/s, and/or the frequency interval of a resource structure may comprise and/or be comprised of subcarrier/s. A resource element may be considered an example for a resource structure, a slot or mini-slot or a Physical Resource Block (PRB) or parts thereof may be considered others. A resource structure may be associated to a specific channel, e.g., a PUSCH or PUCCH, in particular resource structure smaller than a slot or PRB.

Examples of a resource structure in frequency domain comprise a bandwidth or band, or a bandwidth part. A bandwidth part may be a part of a bandwidth available for a radio node for communicating, e.g., due to circuitry and/or configuration and/or regulations and/or a standard. A bandwidth part may be configured or configurable to a radio node. In some variants, a bandwidth part may be the part of a bandwidth used for communicating, e.g., transmitting and/or receiving, by a radio node. The bandwidth part may be smaller than the bandwidth (which may be a device bandwidth defined by the circuitry/configuration of a device, and/or a system bandwidth, e.g., available for a RAN). It may be considered that a bandwidth part comprises one or more resource blocks or resource block groups, in particular one or more PRBs or PRB groups. A bandwidth part may pertain to, and/or comprise, one or more carriers. A resource structure may in time domain comprise and/or represent a time interval, e.g., one of more allocation units and/or symbols and/or slots and/or subframes. In general, any reference to a symbol as a time interval may be considered as a reference to an allocation unit as a more general term, unless the reference to the symbol is specific, e.g., referring to a specific division or modulation technique, or to modulation symbols as transmission structures.

A carrier may generally represent a frequency range or band and/or pertain to a central frequency and an associated frequency interval. It may be considered that a carrier comprises a plurality of subcarriers. A carrier may have assigned to it a central frequency or center frequency interval, e.g., represented by one or more subcarriers (to each subcarrier there may be generally assigned a frequency bandwidth or interval). Different carriers may be non-overlapping, and/or may be neighboring in frequency domain.

It should be noted that the term “radio” in this disclosure may be considered to pertain to wireless communication in general, and may also include wireless communication utilising millimeter waves, in particular above one of the thresholds 10 GHz or 20 GHz or 50 GHz or 52 GHz or 52.6 GHz or 60 GHz or 72 GHz or 100 GHz or 114 GHz. Such communication may utilise one or more carriers, e.g., in FDD and/or carrier aggregation. Upper frequency boundaries may correspond to 300 GHz or 200 GHz or 120 GHz or any of the thresholds larger than the one representing the lower frequency boundary.

A radio node, in particular a network node or a terminal, may generally be any device adapted for transmitting and/or receiving radio and/or wireless signals and/or data, in particular communication data, in particular on at least one carrier. The at least one carrier may comprise a carrier accessed based on an LBT procedure (which may be called LBT carrier), e.g., an unlicensed carrier. It may be considered that the carrier is part of a carrier aggregate.

Receiving or transmitting on a cell or carrier may refer to receiving or transmitting utilizing a frequency (band) or spectrum associated to the cell or carrier. A cell may generally comprise and/or be defined by or for one or more carriers, in particular at least one carrier for UL communication/transmission (called UL carrier) and at least one carrier for DL communication/transmission (called DL carrier). It may be considered that a cell comprises different numbers of UL carriers and DL carriers. Alternatively, or additionally, a cell may comprise at least one carrier for UL communication/transmission and DL communication/transmission, e.g., in TDD-based approaches.

A channel may generally be a logical, transport or physical channel. A channel may comprise and/or be arranged on one or more carriers, in particular a plurality of subcarriers. A channel carrying and/or for carrying control signalling/control information may be considered a control channel, in particular if it is a physical layer channel and/or if it carries control plane information. Analogously, a channel carrying and/or for carrying data signalling/user information may be considered a data channel, in particular if it is a physical layer channel and/or if it carries user plane information. A channel may be defined for a specific communication direction, or for two complementary communication directions (e.g., UL and DL, or sidelink in two directions), in which case it may be considered to have two component channels, one for each direction. Examples of channels comprise a channel for low latency and/or high reliability transmission, in particular a channel for Ultra-Reliable Low Latency Communication (URLLC), which may be for control and/or data.

In general, a symbol may represent and/or be associated to a symbol time length, which may be dependent on the carrier and/or subcarrier spacing and/or numerology of the associated carrier. Accordingly, a symbol may be considered to indicate a time interval having a symbol time length in relation to frequency domain. A symbol time length may be dependent on a carrier frequency and/or bandwidth and/or numerology and/or subcarrier spacing of, or associated to, a symbol. Accordingly, different symbols may have different symbol time lengths. In particular, numerologies with different subcarrier spacings may have different symbol time length. Generally, a symbol time length may be based on, and/or include, a guard time interval or cyclic extension, e.g., prefix or postfix.

A sidelink may generally represent a communication channel (or channel structure) between two UEs and/or terminals, in which data is transmitted between the participants (UEs and/or terminals) via the communication channel, e.g., directly and/or without being relayed via a network node. A sidelink may be established only and/or directly via air interface/s of the participant, which may be directly linked via the sidelink communication channel. In some variants, sidelink communication may be performed without interaction by a network node, e.g., on fixedly defined resources and/or on resources negotiated between the participants. Alternatively, or additionally, it may be considered that a network node provides some control functionality, e.g., by configuring resources, in particular one or more resource pool/s, for sidelink communication, and/or monitoring a sidelink, e.g., for charging purposes.

Sidelink communication may also be referred to as device-to-device (D2D) communication, and/or in some cases as ProSe (Proximity Services) communication, e.g., in the context of LTE. A sidelink may be implemented in the context of V2x communication (Vehicular communication), e.g., V2V (Vehicle-to-Vehicle), V2I (Vehicle-to-Infrastructure) and/or V2P (Vehicle-to-Person). Any device adapted for sidelink communication may be considered a user equipment or terminal.

A sidelink communication channel (or structure) may comprise one or more (e.g., physical or logical) channels, e.g., a PSCCH (Physical Sidelink Control CHannel, which may for example carry control information like an acknowledgement position indication, and/or a PSSCH (Physical Sidelink Shared CHannel, which for example may carry data and/or acknowledgement signalling). It may be considered that a sidelink communication channel (or structure) pertains to and/or used one or more carrier/s and/or frequency range/s associated to, and/or being used by, cellular communication, e.g., according to a specific license and/or standard. Participants may share a (physical) channel and/or resources, in particular in frequency domain and/or related to a frequency resource like a carrier) of a sidelink, such that two or more participants transmit thereon, e.g., simultaneously, and/or time-shifted, and/or there may be associated specific channels and/or resources to specific participants, so that for example only one participant transmits on a specific channel or on a specific resource or specific resources, e.g., in frequency domain and/or related to one or more carriers or subcarriers.

A sidelink may comply with, and/or be implemented according to, a specific standard, e.g., an LTE-based standard and/or NR. A sidelink may utilise TDD (Time Division Duplex) and/or FDD (Frequency Division Duplex) technology, e.g., as configured by a network node, and/or preconfigured and/or negotiated between the participants. A user equipment may be considered to be adapted for sidelink communication if it, and/or its radio circuitry and/or processing circuitry, is adapted for utilising a sidelink, e.g., on one or more frequency ranges and/or carriers and/or in one or more formats, in particular according to a specific standard. It may be generally considered that a Radio Access Network is defined by two participants of a sidelink communication. Alternatively, or additionally, a Radio Access Network may be represented, and/or defined with, and/or be related to a network node and/or communication with such a node.

Communication or communicating may generally comprise transmitting and/or receiving signalling. Communication on a sidelink (or sidelink signalling) may comprise utilising the sidelink for communication (respectively, for signalling). Sidelink transmission and/or transmitting on a sidelink may be considered to comprise transmission utilising the sidelink, e.g., associated resources and/or transmission formats and/or circuitry and/or the air interface. Sidelink reception and/or receiving on a sidelink may be considered to comprise reception utilising the sidelink, e.g., associated resources and/or transmission formats and/or circuitry and/or the air interface. Sidelink control information (e.g., SCI) may generally be considered to comprise control information transmitted utilising a sidelink.

A transmission may generally pertain to a specific channel and/or specific resources, in particular with a starting symbol and ending symbol in time, covering the interval therebetween. A scheduled transmission may be a transmission scheduled and/or expected and/or for which resources are scheduled or provided or reserved. However, not every scheduled transmission has to be realized. For example, a scheduled downlink transmission may not be received, or a scheduled uplink transmission may not be transmitted due to power limitations, or other influences (e.g., a channel on an unlicensed carrier being occupied). A transmission may be scheduled for a transmission timing substructure (e.g., a mini-slot, and/or covering only a part of a transmission timing structure) within a transmission timing structure like a slot. A border symbol may be indicative of a symbol in the transmission timing structure at which the transmission starts or ends.

Predefined in the context of this disclosure may refer to the related information being defined for example in a standard, and/or being available without specific configuration from a network or network node, e.g., stored in memory, for example independent of being configured. Configured or configurable may be considered to pertain to the corresponding information being set/configured, e.g., by the network or a network node.

A configuration or schedule, like a mini-slot configuration and/or structure configuration, may schedule transmissions, e.g., for the time/transmissions it is valid, and/or transmissions may be scheduled by separate signalling or separate configuration, e.g., separate RRC signalling and/or downlink control information signalling. The transmission/s scheduled may represent signalling to be transmitted by the device for which it is scheduled, or signalling to be received by the device for which it is scheduled, depending on which side of a communication the device is. It should be noted that downlink control information or specifically DCI signalling may be considered physical layer signalling, in contrast to higher layer signalling like MAC (Medium Access Control) signalling or RRC layer signalling. The higher the layer of signalling is, the less frequent/the more time/resource consuming it may be considered, at least partially due to the information contained in such signalling having to be passed on through several layers, each layer requiring processing and handling.

A scheduled transmission, and/or transmission timing structure like a mini-slot or slot, may pertain to a specific channel, in particular a physical uplink shared channel, a physical uplink control channel, or a physical downlink shared channel, e.g., PUSCH, PUCCH or PDSCH, and/or may pertain to a specific cell and/or carrier aggregation. A corresponding configuration, e.g., scheduling configuration or symbol configuration may pertain to such channel, cell and/or carrier aggregation. It may be considered that the scheduled transmission represents transmission on a physical channel, in particular a shared physical channel, for example a physical uplink shared channel or physical downlink shared channel. For such channels, semi-persistent configuring may be particularly suitable.

Generally, a configuration may be a configuration indicating timing, and/or be represented or configured with corresponding configuration data. A configuration may be embedded in, and/or comprised in, a message or configuration or corresponding data, which may indicate and/or schedule resources, in particular semi-persistently and/or semi-statically.

A control region of a transmission timing structure may be an interval in time and/or frequency domain for intended or scheduled or reserved for control signalling, in particular downlink control signalling, and/or for a specific control channel, e.g., a physical downlink control channel like PDCCH. The interval may comprise, and/or consist of, a number of symbols in time, which may be configured or configurable, e.g., by (UE-specific) dedicated signalling (which may be single-cast, for example addressed to or intended for a specific UE), e.g., on a PDCCH, or RRC signalling, or on a multicast or broadcast channel. In general, the transmission timing structure may comprise a control region covering a configurable number of symbols. It may be considered that in general the border symbol is configured to be after the control region in time. A control region may be associated, e.g., via configuration and/or determination, to one or more specific UEs and/or formats of PDCCH and/or DCI and/or identifiers, e.g., UE identifiers and/or RNTIs or carrier/cell identifiers, and/or be represented and/or associated to a CORESET and/or a search space.

The duration of a symbol (symbol time length or interval or allocation unit) of the transmission timing structure may generally be dependent on a numerology and/or carrier, wherein the numerology and/or carrier may be configurable. The numerology may be the numerology to be used for the scheduled transmission.

A transmission timing structure may comprise a plurality of allocation units or symbols, and/or define an interval comprising several symbols or allocation units (respectively their associated time intervals). In the context of this disclosure, it should be noted that a reference to a symbol for ease of reference may be interpreted to refer to the time domain projection or time interval or time component or duration or length in time of the symbol, unless it is clear from the context that the frequency domain component also has to be considered. Examples of transmission timing structures include slot, subframe, mini-slot (which also may be considered a substructure of a slot), slot aggregation (which may comprise a plurality of slots and may be considered a superstructure of a slot), respectively their time domain component. A transmission timing structure may generally comprise a plurality of symbols and/or allocation units defining the time domain extension (e.g., interval or length or duration) of the transmission timing structure, and arranged neighboring to each other in a numbered sequence. A timing structure (which may also be considered or implemented as synchronisation structure) may be defined by a succession of such transmission timing structures, which may for example define a timing grid with symbols representing the smallest grid structures. A transmission timing structure, and/or a border symbol or a scheduled transmission may be determined or scheduled in relation to such a timing grid. A transmission timing structure of reception may be the transmission timing structure in which the scheduling control signalling is received, e.g., in relation to the timing grid. A transmission timing structure may in particular be a slot or subframe or in some cases, a mini-slot. In some cases, a timing structure may be represented by a frame structure. Timing structures may be associated to specific transmitters and/or cells and/or beams and/or signallings.

Signalling utilising, and/or on and/or associated to, resources or a resource structure may be signalling covering the resources or structure, signalling on the associated frequency/ies and/or in the associated time interval/s. It may be considered that a signalling resource structure comprises and/or encompasses one or more substructures, which may be associated to one or more different channels and/or types of signalling and/or comprise one or more holes (resource element/s not scheduled for transmissions or reception of transmissions). A resource substructure, e.g., a feedback resource structure, may generally be continuous in time and/or frequency, within the associated intervals. It may be considered that a substructure, in particular a feedback resource structure, represents a rectangle filled with one or more resource elements in time/frequency space. However, in some cases, a resource structure or substructure, in particular a frequency resource range, may represent a non-continuous pattern of resources in one or more domains, e.g., time and/or frequency. The resource elements of a substructure may be scheduled for associated signalling.

Example types of signalling comprise signalling of a specific communication direction, in particular, uplink signalling, downlink signalling, sidelink signalling, as well as reference signalling (e.g., SRS or CRS or CSI-RS), communication signalling, control signalling, and/or signalling associated to a specific channel like PUSCH, PDSCH, PUCCH, PDCCH, PSCCH, PSSCH, etc.).

A signalling sequence may correspond to a sequence of modulation symbols (e.g., in time domain, or in frequency domain for an OFDM system). The signalling sequence may be predefined, or configured or configurable, e.g., to a wireless device. For OFDM or SC-FDM, each element of a signalling sequence may be mapped to a subcarrier; in general, for SC-based signalling, a corresponding mapping in time domain may be utilised (for example, such that each element may use essentially the full synchronisation bandwidth). A signalling sequence may comprise (ordered) modulation symbols, each modulation symbol representing a value of the sequence it is based on, e.g., based on the modulation scheme used and/or in a phase or constellation diagram; for some sequences like Zadoff-Chu sequences, there may be a mapping between non-integer sequence elements and transmitted waveform, which may not be represented in the context of a modulation scheme like BPSK or QPSK or higher. A signalling sequence may be a physical layer signalling or signal, which may be devoid of higher layer information. A signalling sequence may be based on a sequence, e.g., a bit sequence or symbol sequence and/or a modulation, e.g., performed on the sequence. Elements of a signalling sequence may be mapped to frequency domain (e.g., to subcarriers, in particular in a pattern like a comb structure or in interlaces) and/or in time domain, e.g., to one or more allocation units or symbol time intervals. A DFT-s-OFDM based waveform may be a waveform constructed by performing a DFT-spreading operation on modulation symbols mapped to a frequency interval (e.g., subcarriers), e.g., to provide a time-variable signal. A DFT-s-OFDM based waveform may also be referred to a SC-FDM waveform. It may be considered to provide good PAPR characteristics, allowing optimised operation of power amplifiers, in particular for high frequencies. In general, the approaches described herein may also be applicable to Single-Carrier based waveforms, e.g., FDE-based waveforms. Communication, e.g., on data channel/s and/or control channel/s, may be based on, and/o utilise, a DFT-s-OFDM based waveform, or a Single-Carrier based waveform.

A sequence may generally be considered to be based on a root sequence if it can be constructed from the root sequence (or represents it directly), e.g., by shifting in phase and/or frequency and/or time domain, and/or performing a cyclic shift and/or a cyclic extension, and/or copying/repeating and/or processing or operating on with a code, and/or interleaving or re-ordering of elements of the sequence, and/or extending or shortening the root sequence. A cyclic extension of a sequence may comprise taking a part of the sequence (in particular a border part like a tail or beginning) and appending it to the sequence, e.g., at the beginning or end, for example in time domain or frequency domain. Thus, a cyclic extended sequence may represent a (root) sequence and at least a part repetition of the (root) sequence. Operations described may be combined, in any order, in particular a shift and a cyclic extension. A cyclic shift in a domain may comprise shifting the sequence in the domain within an interval, such that the total number of sequence elements is constant, and the sequence is shifted as if the interval represented a ring (e.g., such that starting from the same sequence element, which may appear at different location in the interval), the order of elements is the same if the borders of the intervals are considered to be continuous, such that leaving one end of the interval leads to entering the interval at the other end). Processing and/or operating on with a code may correspond to constructing a sequence out of copies of a root sequence, wherein each copy is multiplied and/or operated on with an element of the code. Multiplying with an element of a code may represent and/or correspond to a shift (e.g., constant, or linear or cyclic) in phase and/or frequency and/or time domain, depending on representation. In the context of this disclosure, a sequence being based on and/or being constructed and/or processed may be any sequence that would result from such construction or processing, even if the sequence is just read from memory. Any isomorphic or equivalent or corresponding way to arrive at the sequence is considered to be included by such terminology; the construction thus may be considered to define the characteristics of the sequence and/or the sequence, not necessarily a specific way to construct them, as there may be multiple equivalent ways that are mathematically equivalent. Thus, a sequence “based on” or “constructed” or similar terminology may be considered to correspond to the sequence being “represented by” or “may be represented by” or “representable as”.

A root sequence for a signalling sequence associated to one allocation unit may be basis for construction of a larger sequence. In this case, the larger sequence and/or the root sequence basis for its construction may be considered root sequence for signalling sequences associated to other allocation units.

For OFDM or SC-FDM, each element of a signalling sequence may be mapped to a subcarrier; in general, for SC-based signalling, a corresponding mapping in time domain may be utilised (such that each element may use essentially the full synchronisation bandwidth). A signalling sequence may comprise (ordered) modulation symbols, each modulation symbol representing a value of the sequence it is based on, e.g., based on the modulation scheme used and/or in a phase or constellation diagram; for some sequences like Zadoff-Chu sequences, there may be a mapping between non-integer sequence elements and transmitted waveform, which may not be represented in the context of a modulation scheme like BPSK or QPSK or higher.

A signalling sequence of an allocation unit may be based on a sequence root, e.g., a root sequence. A sequence root in general may represent or indicate a base for deriving or determining a signalling sequence; the root may be associated to, and/or represent a sequence directly, and/or indicate or represent a base sequence and/or seed. Examples of sequence roots may comprise a Zadoff Chu root sequence, a sequence seed, e.g., a seed for a Gold sequence, or a Golay complimentary sequence. A signalling sequence may be derived or derivable from, and/or be based on, a sequency root, e.g., based on a code, which may represent a shift or operation or processing on the root sequence or a sequence indicated by the sequence root, e.g., to provide the signalling sequence; the signalling sequence may be based on such shifted or processed or operated on root sequence. The code may in particular represent a cyclic shift and/or phase shift and/or phase ramp (e.g., an amount for such). The code may assign one operation or shift for each allocation unit.

In general, a signalling sequence associated to an allocation unit (and/or the allocation units) associated to control signalling (and/or reference signalling) may be based on a root sequence which may be a M-sequence or Zadoff-Chu sequence, or a Gold or Golay sequence, or another sequence with suitable characteristics regarding correlation and/or interference (e.g., self-interference and/or interference with other or neighboring transmitters). Different sequences may be used as root sequences for different signalling sequences, or the same sequence may be used. If different sequences are used, they may be of the same type (Gold, Golay, M- or Zadoff-Chu, for example). The (signalling and/or root) sequences may correspond to or be time-domain sequences, e.g., time domain Zadoff-Chu and/or time-domain M sequences.

Reference signalling may have a type. Types of reference signalling may include synchronisation signalling, and/or DM-RS (used to facilitate demodulation of associated data signalling and/or control signalling), and/or PT-RS (used to facilitate phase tracking of associated data signalling and/or control signalling, e.g., within a time interval or symbol or allocation unit carrying such signalling), and/or CSI-RS (e.g., used for channel estimation and/or reporting). It may be considered that PT-RS are inserted into a bit sequence, or a modulation symbol sequence, which may represent data. For example, PT-RS may be mapped onto subcarriers of a symbol also carrying data symbols. Accordingly, PT-RS insertion may be optimised for hardware implementations. In some cases, PT-RS may be modulated differently and/or independently of the modulation symbols representing data (or data bits).

In general, a clear channel assessment (CCA) procedure may comprise monitoring and/or performing measurements on a frequency range and/or channel and/or carrier and/or spectrum; in some cases a CCA procedure may also be referred to as LBT procedure; e.g., if only one CCA is performed for a LBT procedure. In particular, the CCA procedure may comprise determining whether a channel or frequency range or spectrum or carrier is occupied, for example based on one or more parameters, e.g., measured or monitored energy and/or power and/or signal strength and/or energy density and/or power density or similar. A CCA procedure may be performed and/or pertain to a specific time interval (also referred to as CCA duration), for example a measuring or monitoring interval over which measurement and/or monitoring is performed. The CCA procedure may be performed and/or pertain to a specific frequency range (also referred to as CCA frequency range), for example a measurement and/or monitoring range. The CCA frequency range may be part of and/or comprise the frequency range and/or carrier and/or spectrum and/or channel to be accessed (which may be referred to as access target frequency range, or access target in short; accessing in this context may be considered to refer to transmitting signalling on the range and/or carrier and/or spectrum). The CCA frequency range may be considered representative of the access target frequency range in terms of occupation status (occupied or non-occupied). A CCA procedure may indicate whether the access target is occupied or not, for example by comparing measurement results with one or more threshold values. For example, if the measured power or energy over the CCA duration is lower than an occupancy threshold, the access target may be considered unoccupied; if it reaches or is higher than the threshold, it may be considered occupied. A determination as unoccupied may be considered a positive result; a determination of occupied may be considered a negative result. A Listen-Before-Talk procedure (LBT) may comprise one or more CCA procedure in an LBT time interval, for example with the same duration and/or same condition or threshold for positive result, or with different durations and/or different conditions or thresholds. An LBT procedure may be considered positive if a threshold number of CCAs of the LBT procedure are positive, for example each or half, and/or a minimum consecutive in time are positive. A positive LBT and/or CCA procedure may allow access to the access target for transmission, for example to be accessed within an access time interval. Access (permission to transmit) may be valid for a channel occupation time (COT); the maximum time of access may be a maximum COT (M-COT). The time of access may be referred to as transmission duration (which may be as long as the M-COT or shorter). A radio node like a wireless device does not have to transmit the whole M-COT after successful CCA/LBT. It may be considered that part of the M-COT is passed on to another device, which then may transmit (using the rest of the M-COT), e.g., upon and/or based on suitable control signalling; this may be particularly useful in a centralised system. For example, in centralised system, a base station may initiate an access, transmit DL signalling to a wireless device scheduled for UL transmission such that the wireless device transmits within the M-COT after the DL transmission has ended, e.g., due to suitable scheduling information. The device performing successful access to start transmission at the beginning of a M-COT or COT may be considered the device initiating a COT or M-COT. Depending on whether there is a gap between transmissions of different device, one or more CCA procedures (in particular, shorter in total than for initiation) may have to be performed by the device taking over transmission. If a LBT procedure was unsuccessful, a device may be required to backoff (e.g., not trying to access for a backoff time interval, which may be predefined or random). Accessing and/or transmitting on an access target frequency range may comprise on the whole bandwidth of the frequency range, or on part of it, for example interleaved and/or in a contiguous part and/or utilising frequency hopping, and/or may be based on allocated and/or scheduled and/or configured resources, for example in time domain (e.g., for a number of symbols or a time interval) and/or frequency domain (e.g., as in terms of frequency subranges and/or subcarriers and/or PRBs and/or groups of PRBs assigned for transmission, e.g., allocated or scheduled or configured).

A transmission source may in particular comprise, and/or be represented by, and/or associated to, an antenna or group of antenna elements or antenna subarray or antenna array or transmission point or TRP or TP (Transmission Point) or access point. In some cases, a transmission source may be represented or representable, and/or correspond to, and/or associated to, an antenna port or layer of transmission, e.g., for multi-layer transmission. Different transmission sources may in particular comprise different and/or separately controllable antenna element/s or (sub-) arrays and/or be associated to different antenna ports and/or ports for reference signalling (e.g., such that reference signalling on different ports is shifted relative to each other, e.g., in code domain and/or cyclic shift and/or frequency domain and/or time domain, and/or is based and/or represents a different sequence root). In particular, analog beamforming may be used, with separate analog control of the different transmission sources. An antenna port may indicate a transmission source, and/or a one or more transmission parameter, in particular of reference signalling associated to the antenna port. In particular, transmission parameters pertaining to, and/or indicating a frequency domain distribution or mapping (e.g., which comb to use and/or which subcarrier or frequency offset to use, or similar) of modulation symbols of the reference signalling, and/or to which cyclic shift to use (e.g., to shift elements of a modulation symbol sequence, or a root sequence, or a sequence based on or derived from the root sequence) and/or to which cover code to use (e.g., (e.g., to shift elements of a modulation symbol sequence, or a root sequence, or a sequence based on or derived from the root sequence). In some cases, a transmission source may represent a target for reception, e.g., if it is implemented as a TRP or AP (Access Point).

In the context of this disclosure, there may be distinguished between dynamically scheduled or aperiodic transmission and/or configuration, and semi-static or semi-persistent or periodic transmission and/or configuration. The term “dynamic” or similar terms may generally pertain to configuration/transmission valid and/or scheduled and/or configured for (relatively) short timescales and/or a (e.g., predefined and/or configured and/or limited and/or definite) number of occurrences and/or transmission timing structures, e.g., one or more transmission timing structures like slots or slot aggregations, and/or for one or more (e.g., specific number) of transmission/occurrences. Dynamic configuration may be based on low-level signalling, e.g., control signalling on the physical layer and/or MAC layer, in particular in the form of DCI or SCI. Periodic/semi-static may pertain to longer timescales, e.g., several slots and/or more than one frame, and/or a non-defined number of occurrences, e.g., until a dynamic configuration contradicts, or until a new periodic configuration arrives. A periodic or semi-static configuration may be based on, and/or be configured with, higher-layer signalling, in particular RCL layer signalling and/or RRC signalling and/or MAC signalling.

In this disclosure, for purposes of explanation and not limitation, specific details are set forth (such as particular network functions, processes and signalling steps) in order to provide a thorough understanding of the technique presented herein. It will be apparent to one skilled in the art that the present concepts and aspects may be practiced in other variants and variants that depart from these specific details.

For example, the concepts and variants are partially described in the context of Long Term Evolution (LTE) or LTE-Advanced (LTE-A) or New Radio mobile or wireless communications technologies; however, this does not rule out the use of the present concepts and aspects in connection with additional or alternative mobile communication technologies such as the Global System for Mobile Communications (GSM) or IEEE standards as IEEE 802.11ad or IEEE 802.11 ay. While described variants may pertain to certain Technical Specifications (TSs) of the Third Generation Partnership Project (3GPP), it will be appreciated that the present approaches, concepts, and aspects could also be realized in connection with different Performance Management (PM) specifications.

Moreover, those skilled in the art will appreciate that the services, functions and steps explained herein may be implemented using software functioning in conjunction with a programmed microprocessor, or using an Application Specific Integrated Circuit (ASIC), a Digital Signal Processor (DSP), a Field Programmable Gate Array (FPGA) or general purpose computer. It will also be appreciated that while the variants described herein are elucidated in the context of methods and devices, the concepts and aspects presented herein may also be embodied in a program product as well as in a system comprising control circuitry, e.g., a computer processor and a memory coupled to the processor, wherein the memory is encoded with one or more programs or program products that execute the services, functions and steps disclosed herein.

It is believed that the advantages of the aspects and variants presented herein will be fully understood from the foregoing description, and it will be apparent that various changes may be made in the form, constructions and arrangement of the exemplary aspects thereof without departing from the scope of the concepts and aspects described herein or without sacrificing all of its advantageous effects. The aspects presented herein can be varied in many ways.

### Abbreviation Explanation

5G 5th Generation
BLER Block error rate
BWP Bandwidth Part
CCA Clear Channel Assessment
COT Channel Occupancy Time
CP Cyclic prefix
CSI-RS Channel state information reference signals
CWS Contention Window Size
DBT Discovery Burst Transmission
DL Downlink
DMRS Demodulation Reference Signals
DMTC DRS Measurement Time Configuration
DRS Discovery Reference Signal
DRX Discontinuous Reception
eDRX Extended DRX
ED Energy Detection
eLAA Enhanced License Assisted Access
eNB Evolved NodeB (LTE base station)
feLAA Further Enhanced License Assisted Access
FR1 Frequency range 1 (410-7125 MHZ)
FR2 Frequency range 2 (24-71 GHZ).
gNB NR radio base station
LAA License Assisted Access
LBT Listen-Before-Talk
LTE Long Term Evolution
MAC Medium Access Control
MCOT Maximum Channel Occupancy Time
MHz Megahertz
MIB Master Information Block
NGC Next Generation Core network
NR NR (5G radio access technology specified by 3GPP.)
NR-U NR Unlicensed (NR operation in unlicensed spectrum)
PBCH Physical broadcast channel
PDCCH Physical downlink control channel
PDSCH Physical downlink shared channel
PO Paging occasion
PRS Positioning reference signals
PUCCH Physical uplink control channel
PUSCH Physical uplink shared channel
RAT Radio access technology
RLF Radio Link Failure
RLM Radio Link Monitoring
RRC Radio resource control
RSRP Reference symbol received power
RSRQ Reference symbol received quality
RRM Radio resource management
SCS Subcarrier spacing
SFN System frame number
SFTD SFN and Frame Time Difference
SI System Information
SIB System Information Block
SINR Signal to Interference and Noise Ratio
SMTC SSB measurement timing configuration
SNR Signal to Noise Ratio
SSB Synchronization Signal Block
SRS Sounding reference signal
TDD Time division duplex
TRS Temporary Reference Signals
TT Transmission Time Interval
UCI Uplink Control Information
UE User equipment
UL Uplink

Abbreviations may be considered to follow 3GPP usage if applicable.

1. A method of operating a wireless device in a wireless communication network, the wireless device being configured to operate based on a clear channel assessment, CCA, on one or both of at least one carrier and cell for which an eDRX cycle is configured, the method comprising:
performing one or more radio procedures based on one or more CCA parameters.

2. A wireless device for a wireless communication network, the wireless device being configured to operate based on a clear channel assessment, CCA, on one or both of at least one carrier and cell for which an eDRX cycle is configured, the wireless device being further configured to:
perform one or more radio procedures based on one or more CCA parameters.

3. A method of operating a network node in a wireless communication network, the network node being configured to operate based on a clear channel assessment, CCA, on one or both of at least one carrier and cell for which an eDRX cycle is configured, the method comprising:
performing one or more radio procedures based on one or more CCA parameters.

4. A network node for a wireless communication network, the network node being configured to operate based on a clear channel assessment, CCA, on one or both of at least one carrier and cell for which an eDRX cycle is configured, the network node being further configured to:
perform one or more radio procedures based on one or more CCA parameters.

5. The method according to claim 1, wherein the one or more radio procedures comprise one or both performing measurement and measurement reporting.

6. The method according to claim 1, wherein one or both:
performing the one or more radio procedures is based on a Paging Time Window, PTW; and
a PTW is based on one or more CCA parameters.

7. The method according to claim 1, wherein the one or more CCA parameters comprise one or more of:
determining success or failure of a CCA procedure;
a number of CCA procedures;
a number of successful or failed CCA procedures;
one or more time intervals for determining one or more of a number of CCA procedures and successful and failed CCA procedures; and
one or more occasions, for one or more of paging and transmission and reception.

8. A storage medium storing an executable computer program comprising instructions causing processing circuitry to one or both control and perform a method of operating a wireless device in a wireless communication network, the wireless device being configured to operate based on a clear channel assessment, CCA, on one or both of at least one carrier and cell for which an eDRX cycle is configured, the method comprising:
performing one or more radio procedures based on one or more CCA parameters.

9. (canceled)

10. The wireless device according to claim 2, wherein the one or more radio procedures comprise one or both performing measurement and measurement reporting.

11. The wireless device according to claim 2, wherein one or both:
performing the one or more radio procedures is based on a Paging Time Window, PTW; and
a PTW is based on one or more CCA parameters.

12. The wireless device according to claim 2, wherein the one or more CCA parameters comprise one or more of:
determining success or failure of a CCA procedure;
a number of CCA procedures;
a number of successful or failed CCA procedures;
one or more time intervals for determining one or more of a number of CCA procedures and successful and failed CCA procedures; and
one or more occasions for one or more of paging and transmission and reception.

13. The method according to claim 3, wherein the one or more radio procedures comprise one or both performing measurement and measurement reporting.

14. The method according to claim 3, wherein one or both:
performing the one or more radio procedures is based on a Paging Time Window, PTW; and
a PTW is based on one or more CCA parameters.

15. The method according to claim 3, wherein the one or more CCA parameters comprise one or more of:
determining success or failure of a CCA procedure;
a number of CCA procedures;
a number of successful or failed CCA procedures;
one or more time intervals for determining one or more of a number of CCA procedures and successful and failed CCA procedures; and
one or more occasions for one or more of paging and transmission and reception.

16. The network node according to claim 4, wherein the one or more radio procedures comprise one or both performing measurement and measurement reporting.

17. The network node according to claim 4, wherein one or both:
performing the one or more radio procedures is based on a Paging Time Window, PTW; and
a PTW is based on one or more CCA parameters.

18. The network node according to claim 4, wherein the one or more CCA parameters comprise one or more of:
determining success or failure of a CCA procedure;
a number of CCA procedures;
a number of successful or failed CCA procedures;
one or more time intervals for determining one or more of a number of CCA procedures and successful and failed CCA procedures; and
one or more occasions for one or more of paging and transmission and reception.

19. The method according to claim 5, wherein one or both:
performing the one or more radio procedures is based on a Paging Time Window, PTW; and
a PTW is based on one or more CCA parameters.

20. The method according to claim 19, wherein the one or more CCA parameters comprise one or more of:
determining success or failure of a CCA procedure;
a number of CCA procedures;
a number of successful or failed CCA procedures;
one or more time intervals for determining one or more of a number of CCA procedures and successful and failed CCA procedures; and
one or more occasions for one or more of paging and transmission and reception.

21. The method according to claim 5, wherein the one or more CCA parameters comprise one or more of:
determining success or failure of a CCA procedure;
a number of CCA procedures;
a number of successful or failed CCA procedures;
one or more time intervals for determining one or more of a number of CCA procedures and successful and failed CCA procedures; and
one or more occasions for one or more of paging and transmission and reception.
